(19) United States
(12) Patent Application Publication
(10) Pub. No.: US 2020/0391921 A1
(43) Pub. Date: Dec. 17, 2020

(54) FLEXIBLE BAGS AND PRODUCTS THEREIN HAVING EXTENDED SHELF LIFE

(71) Applicant: Liqui-Box Corporation, Richmond, VA (US)

(72) Inventor: Adrian Ellis Jackson, Folsom, CA (US)

(21) Appl. No.: 17/004,438

(22) Filed: Aug. 27, 2020

Related U.S. Application Data
(63) Continuation-in-part of application No. 15/931,897, filed on May 14, 2020.
(60) Provisional application No. 62/847,408, filed on May 14, 2019.

(51) Int. Cl. B65D 75/58; B65D 75/30; B65D 81/18; B65D 85/72; B32B 27/08; B32B 27/30; B32B 27/36; B32B 27/32; B65B 31/04; B65B 3/02

(52) U.S. Cl. CPC B65D 75/5877; B65D 75/30; B65D 81/18; B65D 85/72; B32B 27/08; B32B 27/306; B32B 2439/46; B32B 27/32; B65B 31/04; B65B 3/02; B32B 2255/10; B32B 2255/205; B32B 27/36

(57) ABSTRACT

This disclosure provides methods and articles of manufacture (e.g., flexible bags) that extend the shelf life of packaged food products, such as wine, that are susceptible to oxidation. Oxygen transport into the product (e.g., wine) through the flexible-bag walls reduces the shelf life of the product. Similarly, oxygen in air trapped in headspace of a flexible bag packaged with the food product (e.g., wine) eventually dissolves or permeates into the product, and can reduce shelf life and the quality of the product. This disclosure relates flexible bags that provide inert gas cavities around the food product (e.g., wine) and in the headspace above the food product, and the process of making such flexible bags, such that the total oxygen content inside an unfilled (with product) flexible bag is less than 10%.

### CROSS REFERENCE TO RELATED APPLICATIONS

This application is a continuation in part of, and claims the benefit of priority to, U.S. patent application Ser. No. 15/931,897, filed May 14, 2020, which claims the benefit of U.S. Provisional Application No. 62/847,408, filed May 14, 2019. These applications are incorporated herein by reference in their entireties for all purposes.

### TECHNICAL FIELD

The disclosure relates to products and methods that extend the shelf life of food products (e.g., wine) packaged in flexible bags. Oxidation of packaged food products, via oxygen transport into the product through flexible-bag walls can reduce shelf life. Similarly, oxygen in air trapped in headspace of the flexible bag packaging containing the food product can also contribute to product oxidation and shorten its shelf life. The flexible bags described herein reduce the amount of oxygen that can reside in typical packaging (e.g., cavities and in the headspace above the product) by purging atmospheric oxygen with a non-oxidizing or an inert material during the bag production process, such that the total oxygen content inside the flexible bag, without product, is less than 10%.

### BACKGROUND

Generally, laminate films can be used to produce flexible bags or pouches that are filled with flowable materials. These laminate films are typically made from polyolefins, such as those described in U.S. Pat. Nos. 4,503,102; 4,521,437; 5,206,075; 5,364,486; 5,508,051; 5,721,025; 5,879,768; 5,942,579; 5,972,443; 6,117,465; 6,256,966; 6,406,765; 6,416,833; and 6,767,599. These patents describe polymer blends useful in the manufacture of flexible packaging for flowable materials, including foods and beverages, and are incorporated herein by reference in their entireties.

Flexible packaging has a number of physical characteristics that contribute to its usability and applications, particularly when used as food packaging. For example, the packaging needs to be workable such that it is able to be easily and quickly manipulated by packaging/assembly line machinery. The packaging material also needs to be resilient and have a level of quality such that is avoids breaks or leaks and allows for safe product storage. For food products in particular, the packaging materials also provide some amount of an oxygen barrier to maintain product freshness (i.e., avoid oxidation). Oxygen exposure can reduce the shelf life of a packaged food product and may lead to product fouling, spoilage, or degradation that can be associated with changes in color, taste, or odor of the food packaged in the flexible-bag. For example, one study conducted by the French National Institute of Agricultural Research (IRA), identified that an additional 1 mg of oxygen per liter of wine reduces its shelf life by one month. (See, FIG. 1).

Two significant sources of oxygen infiltration in flexible bags used as food packaging include the total atmospheric oxygen content in an unfilled bag, and oxygen permeation (transmission) through the flexible bag walls to the food product. For example, aseptic packaging processes often use an aseptic steam sterilization system to process bags prior to filling. Steam-sterilized bags have been shown to have an increased oxygen transmission rate. For some products where a longer shelf stable product is desirable (e.g., wine in flexible packaging has a desired shelf life of 9-12 months) processes and materials need to be developed that result in reduced oxygen content of the bags before filling, and in reduced oxygen penetration through the packaging after the filling process. Therefore, there is a need and desire to produce flexible bags that have a reduced oxygen transmission rate (OTR), as well as an overall reduction in residual oxygen content of the flexible bag prior to its filling with products, particularly flowable and/or liquid products.

### SUMMARY

This disclosure provides alternative solutions (compositions and methods) that are capable of prolonging the shelf-life and avoiding degradation of packaged products, and particularly flowable packaged food products. In particular, the disclosure provides flexible-bags comprising inert or non-oxidizing gas-filled cavities, in which, the oxygen concentration prior to the filling of the product in various cavities is less than 10%.

This disclosure also relates to the process of making flexible-bags, wherein a non-oxidizing and/or inert material (e.g., liquid or gas) is introduced during the making of the flexible bags, and prior to the sealing of the edges of the flexible bags. It is the first time that the flexible-bag has been made that has closed cavities comprising inert gas, which were made during the flexible-bag manufacturing process, prior to filling of the product.

In an aspect the disclosure relates to a flexible bag for packaging a product to reduce the impact of oxygen on the product and/or to increase said product's shelf life, wherein the flexible bag comprises sealed edges that form at least one cavity; wherein the flexible bag comprises at least one fitment in closed position on one side of the flexible bag for filling it with product(s); wherein the at least one cavity comprises a gas, wherein the gas comprises less than 10% oxygen before filling the flexible bag with product(s); and wherein the flexible bag is made from polymeric films.

In one aspect the disclosure relates to a flexible bag for packaging a food product, wherein the flexible bag comprises: at least one polymeric film that forms at least one cavity, wherein the at least one cavity comprises a non-oxidizing, inert, or substantially inert material (e.g., gas or liquid) comprising less than 10% oxygen; and at least one fitment in closed position on a side, wherein the at least one fitment provides access to the cavity. In embodiments of this aspect, the flexible bag comprises four sealed edges. In embodiments of this aspect, the flexible bag comprises more than one cavity (e.g., 2, 3, 4, 5, 6, 7, 8, 9, or 10 or more cavities), wherein each cavity is formed by two or four layers of at least one polymeric film.

In further embodiments of this aspect, the disclosure provides a flexible bag comprising at least three cavities: a first cavity, a second cavity, and a third cavity wherein at least one cavity comprises a non-oxidizing, inert, or substantially inert material (e.g., gas or liquid) comprising less than 10% oxygen; wherein the first cavity is defined by a first polymeric film layer and a second polymeric film layer; wherein the second cavity is defined by the second polymeric film layer and a third polymeric film layer; and wherein the third cavity is defined by the third polymeric film layer and a fourth polymeric film layer. In such embodiments, the first, second, third, and fourth polymeric film layers may be coplanar, and sealed at the edges; and the second cavity may be central to (located or sandwiched between) the first cavity and the third cavity. In such embodiments, the second cavity may be used for filling the product and may be connected to the fitment. In some of these above embodiments, more than one or all of the at least three cavities, prior to being filled with the product, comprise the gas.

In some embodiments of the above aspects and embodiments, at least one of the first polymeric film layer or the fourth polymeric film layer may comprise metallized PET, metallized BoPA, or clear BoPA; and at least one of the second polymeric film layer or the third polymeric film layer comprises EVOH co-ex, BoPA co-ex, or a combination of both.

In some embodiments of the above aspects and embodiments, the flexible bag may comprise one cavity that is defined by a first polymeric film layer and a second polymeric film layer; wherein the first and second polymeric film layers are coplanar, and sealed at the edges; and wherein the cavity, prior to being filled with product, comprises the gas. In some further embodiments, the first polymeric film layer and the second polymeric film layer may comprise the following layers: (A) a sealant layer comprising LLDPE; (B) an OTR-reducing barrier layer comprising metallized PET, metallized BoPA, or clear BoPA, or a combination thereof; and (C) an FCR-improving layer comprising EVOH coex, BoPA co-ex, or a combination thereof.

In any of the above aspects and embodiments, the at least 90% of the inert material (e.g., gas) comprises nitrogen, argon, helium, or a combination thereof. In any of the above aspects and embodiments, at least 90% of the inert material (e.g., gas) comprises nitrogen. In any of the above aspects and embodiments, at least 99% of the inert material (e.g., gas) comprises nitrogen.

In another aspect, the disclosure provides a process for preparing a flexible bag that extends shelf-life of a food product packaged within the flexible bag, the process comprising: providing at least one polymeric film; forming the at least one polymeric film to create at least one cavity; introducing a portion of a non-oxidizing, inert, or substantially inert material into the at least one cavity from an external source; replacing residual air in the at least one cavity with the material; sealing the at least one cavity to trap the material inside; and repeating the above steps for the next flexible bag in a continuous or a stop start process of flexible bag-making. In further embodiments of this aspect, the method further comprises introducing a fitment on the flexible bag.

In some embodiments of this aspect, the material comprises a gas or liquid that is introduced to the cavity through at least one main tube. In further embodiments, the at least one main tube comprises multiple inlet ports for introducing the gas to replace the residual air in the at least one cavity of the flexible bag. In some further embodiments, the multiple inlet ports may be located at the ends of multiple sub-tubes emanating from the at least one main tube. In further embodiments, the multiple sub-tubes may be of varying lengths. In yet further embodiments, the multiple-sub-tubes may be organized in a gradually-increasing-in-length or a gradually-decreasing-in-length fashion.

In some embodiments of this aspect, the process may further comprise providing first, second, third, and fourth polymeric film layers; forming the first, second, third, and fourth polymeric film layers to create first, second, and third cavities; introducing, from an external source, an amount of a non-oxidizing, inert, or substantially inert material into the first cavity through a first main-tube connected to the first cavity and external source; introducing, from an external source, an amount of a non-oxidizing, inert, or substantially inert material into the second cavity through a second main-tube connected to the second cavity and external source; introducing, from an external source, an amount of a non-oxidizing, inert, or substantially inert material into the third cavity through a third main-tube connected to the third cavity and external gas source; replacing residual air in the three cavities with the material; sealing the three cavities to trap the material inside. Some embodiments may further provide for sweeping the residual air out, or burping the cavities to remove gas. Some further embodiments relate to repeating the above steps for the next flexible bag in a continuous or a stop start process of flexible bag-making. Yet further embodiments comprising introducing a fitment to the flexible bag.

In yet further embodiments, at least one of the first, second, or third main-tubes may comprise multiple inlet ports for introducing the material to replace the residual air in the three cavities. In further embodiments, the multiple inlet ports may be located at the ends of multiple sub-tubes emanating from the first, second, and third main-tubes, and wherein the multiple sub-tubes of at least one of the first, second, and the third main-tubes are of various lengths. In yet further embodiments, the multiple sub-tubes of at least one of the first, second, and the third main-tubes may be organized in a gradually-increasing-in-length and/or a gradually-decreasing-in-length fashion.

In any of the above aspects and embodiments the inert material may comprise a gas. In embodiments, the material (e.g., gas) may be introduced in the at least one cavity in a turbulent flow. In embodiments, the turbulent flow creates a circular flow of gas that displaces the residual air in the at least one cavity. In some embodiments, the material may be introduced from an external source. In further embodiments, the external source may be an external gas source. In embodiments, the inert material (e.g., gas) may comprise nitrogen, argon, helium, or a combination thereof. In some embodiments, the inert material comprises nitrogen gas. In further embodiments the inert material consists essentially of nitrogen gas.

In another aspect, the disclosure relates to a packaged food product comprising: a food product; and a flexible bag comprising at least one polymeric film and that forms a plurality of cavities, wherein one cavity of the plurality of cavities contains a food product and the remaining cavities of the plurality of cavities comprise a non-oxidizing, inert, or substantially inert gas comprising less than 10% oxygen; and at least one fitment in closed position on a side, wherein the at least one fitment provides access to the cavity containing the food product.

In some embodiments, the packaged food product comprises a food product; and a flexible bag comprising first and second polymeric films that are coplanar and sealed at the edges to form one cavity, wherein the cavity contains the food product; and at least one fitment in closed position on a side, wherein the at least one fitment provides access to the cavity containing the food product; wherein the cavity, prior to and after being filled with the food product, comprises a non-oxidizing, inert, or substantially inert gas comprising less than 10% oxygen.

In some embodiments, the packaged food product comprises a bag comprising at least three cavities: a first cavity, a second cavity, and a third cavity; wherein the first cavity is defined by a first polymeric film layer and a second polymeric film layer; wherein the second cavity is defined by the second polymeric film layer and a third polymeric film layer; wherein the third cavity is defined by the third polymeric film layer and a fourth polymeric film layer; wherein the first, second, third, and fourth polymeric film layers are coplanar, and sealed at the edges; wherein the second cavity is central to the first cavity and the third cavity; wherein the second cavity contains the food product and is connected to the fitment; and wherein said first and third cavities comprise the gas. In some embodiments, the plurality of cavities are formed by two layers of polymeric film.

In any of the above aspects and embodiments, the packaged food product may comprise a flexible bag having four sealed edges.

In any of the above aspects and embodiments, the inert material (e.g., liquid or gas) may be a gas wherein at least 90% of the gas may comprise nitrogen, argon, helium, or a combination thereof. In further embodiments, at least 90% of the gas comprises nitrogen. In yet further embodiments, at least 99% of the gas comprises nitrogen.

In any of the above aspects and embodiments, one or more of the polymeric film layers may comprise metallized PET, metallized BoPA, or BoPA co-ex, or a combination thereof. In any of the above aspects and embodiments, one or more of the polymeric film layers may comprise EVOH co-ex, BoPA co-ex, or combination of both. In some further embodiments, the flexible bag of the packaged food product comprises a plurality of polymer film layers, wherein one or more film layers may comprise metallized PET, metallized BoPA, or BoPA co-ex, or a combination thereof, and one or more of the polymeric film layers may comprise EVOH co-ex, BoPA co-ex, or combination of both. In some embodiments, the packaged food product may comprise three of more layers comprising (A) a sealant layer comprising LLDPE; (B) an OTR-reducing barrier layer; and (C) an FCR-improving layer comprising EVOH coex.

In any of the above aspects and embodiments, the food product may be selected from: (A) wine, (B) beer, (C) water, (D) milk (dairy products), (E) non-alcoholic beverages, (F) alcoholic beverages (e.g., distilled spirits), (G) aerated water, (H) energy drinks, (I) fruit juices, (J) vegetable juices, (K) edible oils; (L) syrups; (M) drink mixes; (N) chemicals, and (O) detergents. In some embodiments chemicals include non-edible oils, including hygroscopic oils such as, for example, motor oils, lubricants, brake fluids, and hydraulic fluids. Other examples of chemicals include polyols (e.g., glycerol, ethylene glycol, etc.), alcohols (e.g., ethanol, methanol, etc.), acids (acetic acid, sulfuric acid, etc.), fertilizers, paints and coatings, adhesives, and salts.

Other aspects and embodiments will be apparent in light of the disclosure that follows.

### BRIEF DESCRIPTION OF DRAWINGS

FIG. 1 shows oxygen accumulation (nucleation sites) during filling of wine;

FIG. 2 shows a typical flexible bag packaged with wine;

FIG. 3 is a triple-cavity flexible bag in accordance with an example embodiment of the disclosure;

FIG. 4 is a multiple-cavity flexible bag in accordance with an example embodiment of the disclosure;

FIG. 5A shows various constructions of the single-cavity bag in accordance with an example embodiment of the disclosure;

FIG. 5B shows various further constructions of the single-cavity bag in accordance with an example embodiment of the disclosure;

FIG. 6 shows the process in accordance with an example embodiment of the disclosure;

FIG. 7 shows the inert material (e.g., gas/nitrogen) flow in the flexible bag cavities;

FIG. 8A shows the various tubes constructions that can be used to create an inert gas environment in bag cavities prior to edge sealing;

FIG. 8B shows the various tubes constructions that can be used to create an inert gas environment in bag cavities prior to edge sealing;

FIG. 9 shows the Residual Air Test procedure;

FIG. 10 depicts the general construction of a flexible bag wall in accordance with an example embodiment of the disclosure for improved properties at high Relative Humidity %;

FIG. 11 depicts the Met-Flex film manufactured with thermally-laminated three layers;

FIG. 12 depicts the Met-Flex Film manufactured using extrusion lamination/coating process;

FIG. 13 depicts the Met-Flex film manufactured using extrusion lamination with co-extrusion multilayer technology;

FIG. 14 depicts the Met-Flex film manufactured using extrusion lamination with thermal lamination;

FIG. 15 depicts the Met-Flex film manufactured using adhesive lamination;

FIG. 16 depicts the Met-Flex film manufactured according to another aspect of the disclosure;

FIG. 17 shows an air cone in a bag; and

FIG. 18 shows a graphical representation of the life cycle oxygen management.

FIG. 19A-C depict example embodiments of a device that may be used in processes for forming a bag having at least one cavity that contains a reduced amount of oxygen relative to atmospheric oxygen levels, (e.g., less than about 10% oxygen) in accordance with example aspects and embodiments described herein.

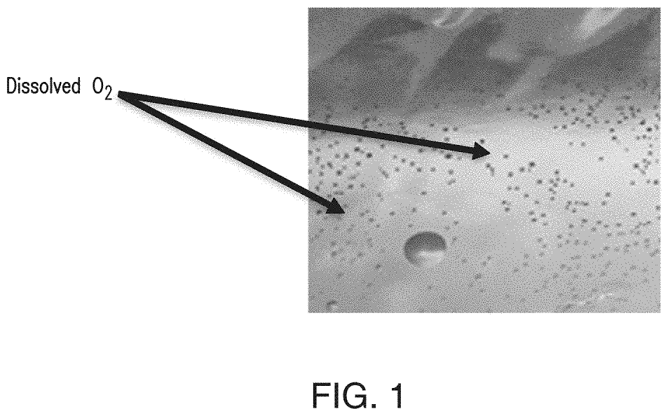

### DETAILED DESCRIPTION

### Definitions

By “FCR” is meant flex-crack resistance, which may be measured and/or determined by the ways disclosed herein or as otherwise known in the art.

By “OTR” is meant oxygen-transmission rate, which may be measured and/or determined by the ways disclosed herein or as otherwise known in the art.

The terms “flexible bags,” “bags,” and “pouches” are used interchangeably herein and may refer to any size of such container for a flowable material.

By “flowable” materials refers herein to materials which can flow as liquid, powder, suspension, emulsion, paste, gel, semi-solid and the like, under gravity or which may be pumped. Included in the term are food products and ingredients in liquid, powder, paste, oils, granular or the like forms, of varying viscosity are envisaged. Normally such materials are not gaseous. But materials with gas bubbles, for example, are within the scope of the disclosure. Materials used in method for utility purposes, manufacturing, and medicine are also considered to fall within such materials.

Flexible Bags

The flexible film and bags in the aspects and embodiments disclosed herein are suitable for packaging of products that may be impacted by exposure to oxygen, over time. Stated another way, the flexible film bags of the disclosure are suitable for use in packaging of products where oxidation of the product is to be reduced or avoided.

In the disclosure, edible, industrial, and other items are listed to provide a broad spectrum of products to which the bags and methods described herein can be applied, but the list is by no means exhaustive. Stated differently, the disclosure relates to packaged items that need or benefit from protection from oxygen.

The flexible bags in example embodiments in accordance with the disclosure can be used for packaging, for example, the following:

beverages such as wine, beer, milk, a non-alcoholic beverage, an alcoholic beverage not including wine or beer, water, carbonated water, soda, non-alcoholic wine coolers, energy drinks, and juices including, but not limited to, fruit or vegetable juices;

edible items or their precursors, such as sauces, syrups, mustard, ketchup, food dressings, cheese, sour-cream, yoghurt, mayonnaise, salad dressings, relish, oil, margarine, coffee concentrate, pastes, puree, ice cream mix, milk shake mix, preserves, emulsions, doughnut fillings, jellies, coffee beans; and dried and freeze-dried food items, including powders (e.g., coffee and tea).

The flexible bags in example embodiments in accordance with the disclosure can be used for packaging, for example, the following:

chemicals, detergents, non-edible oils, preferably the ones that are hygroscopic, for example, oils including motor oils, lubricants, brake fluids, and hydraulic fluids; and

other examples of chemicals include glycerol, ethanol, methanol, sulfuric acid, fertilizer chemicals, paints and coatings, adhesives, salts, emulsions, caulking material, medicines, and materials used in manufacturing.

In another embodiment, the disclosure relates to a packaged flexible bag, comprising one of the above listed products.

As recognized in food and beverage packaging, oxygen dissolved in or in contact with a product, such as wine, in packaging such as flexible bags, is detrimental to product shelf life and degrades the product. If the oxygen level in the packaged liquid product increases or is sustained, the product stands to lose its character, for example, its taste or fragrance, and even its utility (i.e., it may become inedible). In some circumstances, oxygen can enter or contact the products from the outside atmosphere, by penetrating through the flexible-bag walls.

The disclosure addresses the problems caused by oxygen in products packaged in flexible bags. More specifically, the flexible bags in accordance with the aspect and embodiments of the disclosure help minimize oxygen transport across film layers and overall exposure of the product(s) to oxygen.

The disclosure also relates to flexible bags packaged with products, which show reduction in oxygen transport from outside environment into the packaged product through the polymeric film layers of the flexible bag. This disclosure reduces the oxygen transport by providing inert-gas filled pockets or cavities encasing the product. This disclosure also relates to the process of creating inert-gas filled pockets or cavities in the flexible bag during the flexible bag manufacture in a dynamic fashion.

In some embodiment, the disclosure relates to a flexible bag for packaging one of the following products: (A) wine, (B) beer, (C) water, (D) milk, (E) a non-alcoholic beverage, (F) an alcoholic beverage not including wine or beer, (G) aerated water, (H) an energy drink, (I) fruit juice, (J) vegetable juice, (K) chemical, and (L) detergent. In example embodiments, wine, as a product packaged in flexible bag, is used to illustrate certain features of the disclosure in the Examples below. Nevertheless, the illustrative embodiment provided by wine may be expanded, modified, adapted and applied to all the other products and product categories listed in this disclosure.

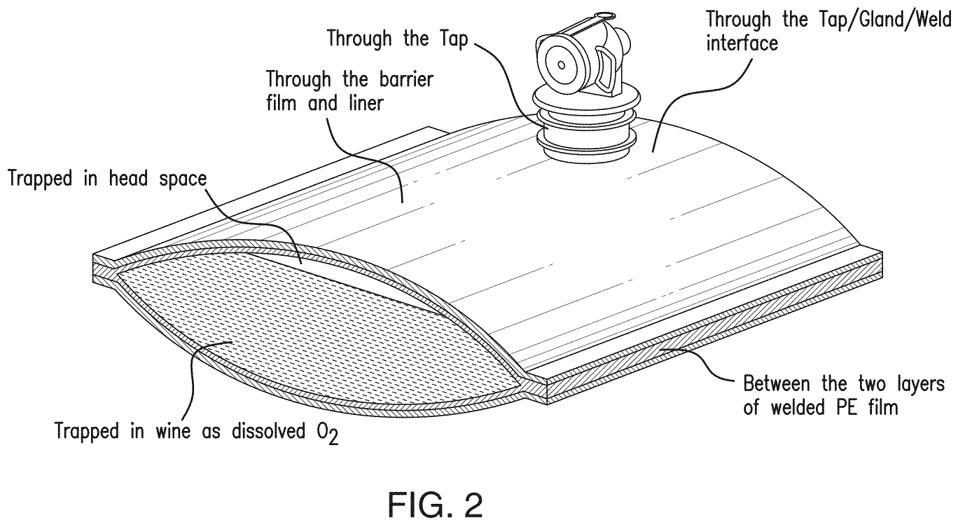

FIG. 2 depicts a flexible bag that is filled with wine. It also shows the various sources from which oxygen can ingress and potentially negatively impact the wine quality. More specifically, the oxygen can transport into the product (wine) through the packaging materials during the filling process and the distribution process. Generally, packaged products like wine (e.g., liquids) can be exposed to oxygen from several identifiable sources, including:

(1) oxygen in air trapped in headspace of the packaged wine;

(2) oxygen in air from outside environment transporting through the flexible walls;

(3) oxygen in air trapped between the two flexible polymeric films on one or both walls of the bag;

(4) oxygen dissolved in wine;

(5) oxygen in air trapped in the dead-space of the dispensation fitment (tap); and

(6) oxygen in air from the outside atmosphere leaking into the product through the operation of the dispensation fitment, or the weld interface of the fitment with the flexible bag.

Thus, certain example embodiments of the disclosure relate to reducing, removing, and/or replacing the oxygen in air that is trapped in headspace of packaged wine; the oxygen in air from the outside environment that is able to transport through the flexible walls; and oxygen in air trapped between two flexible polymeric films that may form one or both walls of the bag, or one or more cavities within a flexible bag.

Three-Cavity Flexible Bag

In some embodiments, a flexible bag may be in the unfilled state, or in filled state, for example packaged wine. FIG. 2 shows a typical construction of the flexible bag in a square or rectangular-shape that is filled with wine (or other liquid/flowable product). The bag comprises two walls that are sealed at the edges (four edges of the square or a rectangular construction) thereby forming a cavity for packaging wine inside the cavity. Each wall is made of two polymeric films not laminated to each other. Thus, one additional cavity is formed within each wall; that is a total of two cavities in addition to the wine-packaging cavity. Stated another way, this flexible-bag embodiment illustrated by FIG. 2 comprises two walls, four polymeric films, and three cavities including the packaging cavity. Each polymeric film can be a single-layer or a laminate of multiple layers. By laminate is meant that the multiple layers of the polymeric film adhere to each other in a planar fashion. At least on one of the two walls is attached a dispensation fitment.

The three-cavity flexible bag in the unfilled state is sealed at the edges to form the central cavity for filling with a product such as wine. The dispensation fitment or tap may be in a closed position. In embodiments of the disclosure, prior to wine filling, the central cavity comprises mostly non-oxidizing material (e.g., inert gas) that contains less than 10% oxygen, instead of containing residual trapped air (and atmospheric amounts of oxygen). In contrast, air typically has 20-21% oxygen and 78% nitrogen. Similarly, the other two cavities that are present between the two non-laminated polymeric films of the wall, also comprise mostly non-oxidizing material (e.g., inert gas) that contains less than 10% oxygen, instead of containing residual trapped air (and atmospheric amounts of oxygen).

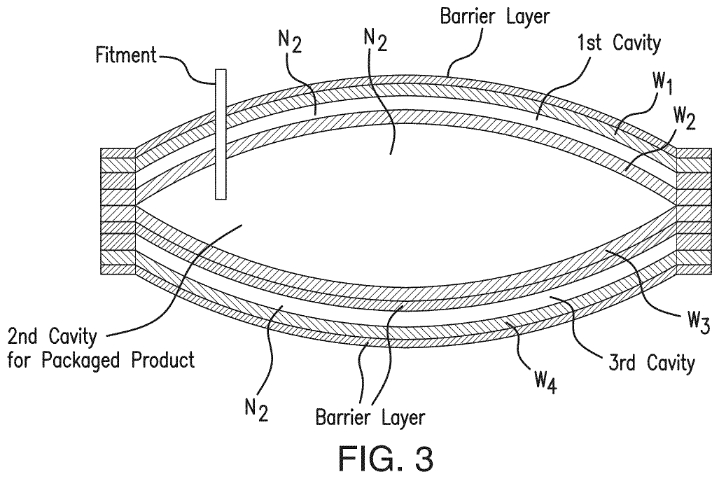

An exemplary triple-cavity bag is depicted in FIG. 3. It has four flexible walls, W1, W2, W3, and W4. Cavity 1 is formed by walls W1 and W2. Cavity 2 is formed by walls W2 and W3. Cavity 3 is formed by walls W3 and W4. In one embodiment, walls W1, W2, W3, and/or W4 can be a single-layer, double-layer or multiple-layer film/s. In one embodiment, walls W1, W2, W3, and/or W4 can have at least one barrier layer. In another embodiment, the barrier layer is metalized, for example, Met-Flex. By Met-Flex is meant the film construction described herein (e.g., “Polymeric Films—Various Embodiments”) and in the U.S. patent application Ser. No. 16/749,207, which is incorporated by reference herein.

An example embodiment of a barrier layer is described herein. The single-cavity bag described in some embodiments shows several schematics of its exemplary embodiments especially as it relates to the variation in the wall films, and barrier layers. Those variations are incorporated herein for the walls of the triple-cavity flexible-bag. In some embodiments, at least one of those cavities is substantially filled with a non-oxidizing or inert material or gas. In one embodiment, all cavities are filled with the non-oxidizing or inert material, such as a substantially inert gas that is comprises than 10% oxygen (by weight or volume).

Multiple-Cavity Flexible-Bags

The disclosure provides example embodiments relating to a flexible bag that has a total of 2-10 cavities. In other words, apart from the cavity for packaging product (such as wine), the walls can include another 1-9 cavities. The disclosure provides embodiments that comprise more cavities in one wall and fewer cavities in the other wall. In embodiments, one wall does not have any cavity and is simply a single-layer or a multi-layer laminated film. In embodiments, the second wall can include all the cavities.

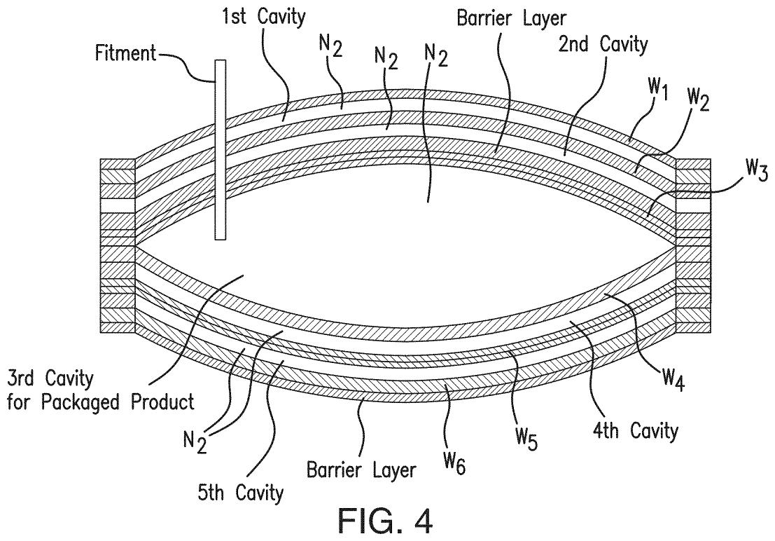

FIG. 4 shows a schematic of a five-cavity flexible bag of the disclosure, having an asymmetric structure in terms of the ply/wall arrangement. It comprises six flexible walls, W1, W2, W3, W4, W5, and W6. Cavity 1 is formed by walls W1 and W2. Cavity 2 is formed by walls W2 and W3. Cavity 3 is formed by walls W3 and W4. Cavity 4 is formed by walls W4 and W5. Cavity 5 is formed by walls W5 and W6. In one embodiment of the disclosure, walls W1, W2, W3, W4, W5, and/or W6 can be a single-layer, a double-layer, or a multiple-layer film/s. In one embodiment, walls W1, W2, W3, W4, W5, and/or W6 can have at least one barrier layer. In another embodiment, the barrier layer is METFLEX type, and exemplary barrier layers are described throughout the disclosure. The single-cavity bag disclosed illustrates several schematics of example embodiments, including those that relate to the variation in the wall films and barrier layers. Those variations are incorporated herein for the walls of the multiple-cavity flexible-bag. In some embodiments, at least one of those cavities is substantially filled with non-oxidizing or inert material (or gas). In one embodiment, all cavities are filled with the substantially non-oxidizing or inert material (gas) that comprises less than 10% oxygen.

Single-Cavity Flexible Bag

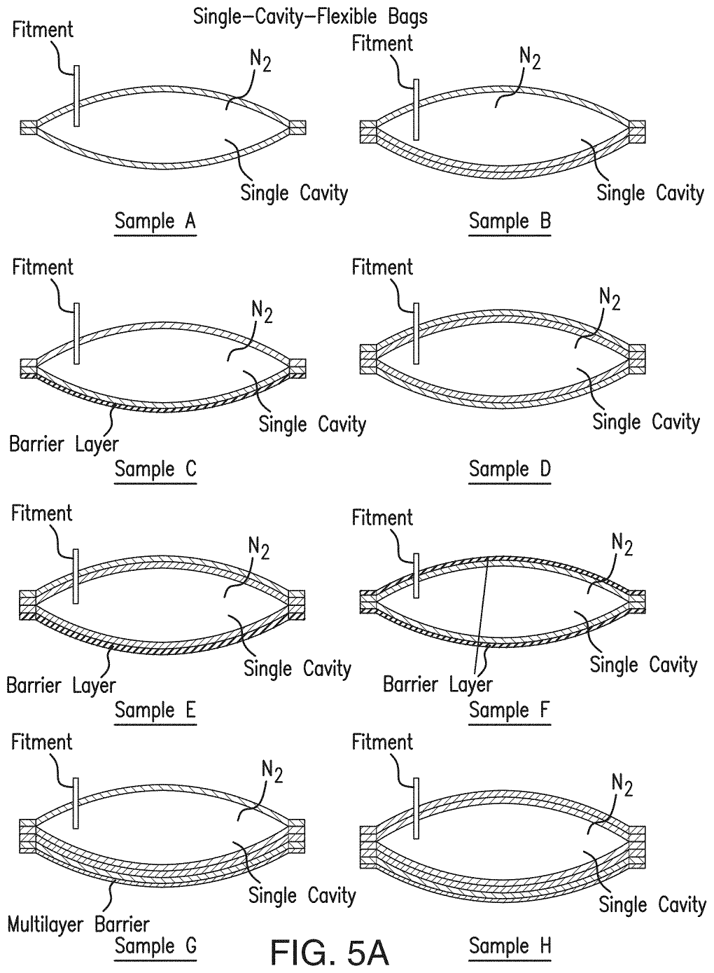

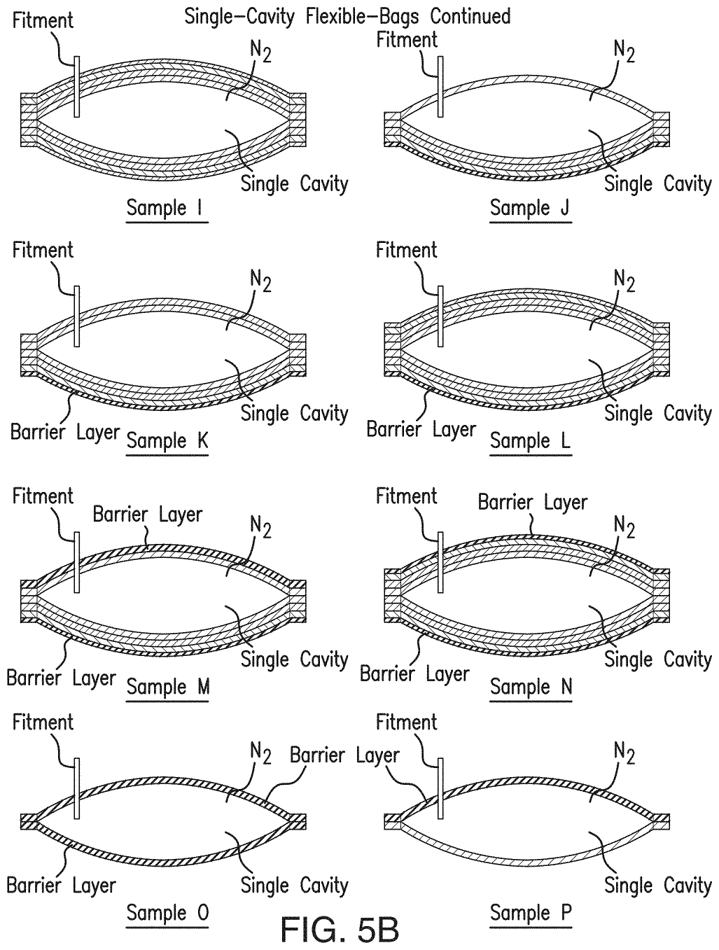

In some example embodiments, the flexible bag comprises two walls forming a single cavity that forms the packaging cavity. The walls may be made of single-layer polymeric film or multi-layer laminate polymeric film. The packaging cavity, in the unfilled state, comprises an amount of the substantially non-oxidizing/inert material or gas trapped inside, and which comprises less than 10% oxygen. In exemplary embodiments comprising the single-cavity bag, at least one wall of the bag is a double-layer laminate or a multi-layer laminate. In other exemplary embodiments, at least one wall of the bag is a double layer laminate or a multi-layer laminate, and at least one of those walls has an external barrier layer such as, for example, a METFLEX type of a barrier layer, or another type of barrier layer as described herein. FIGS. 5A-5B illustrate some exemplary constructions of the single-cavity flexible bag. The bag characteristics are summarized in Table 1 below:

TABLE 1
Bag Characteristics

| | | | Wall 1 + | Wall 2 + |
|---|---|---|---|---|
| | | | Barrier | Barrier |
| Id. | Wall 1 | Wall 2 | Layer | Layer |
| A. | Single Layer | Single Layer | No | No |
| B. | Single Layer | Double Layer | No | No |
| C. | Single Layer | Double Layer | No | Yes |
| D. | Double Layer | Double Layer | No | No |
| E. | Double Layer | Double Layer | No | Yes |
| F. | Double Layer | Double Layer | Yes | Yes |
| G. | Single Layer | Multiple Layer | No | Yes |
| H. | Double Layer | Multiple Layer | No | No |
| I. | Multiple Layer | Multiple Layer | No | No |
| J. | Single Layer | Multiple Layer | No | No |
| K. | Double Layer | Multiple Layer | No | Yes |
| L. | Multiple Layer | Multiple Layer | No | Yes |
| M. | Double Layer | Multiple Layer | Yes | Yes |
| N. | Multiple Layer | Multiple Layer | Yes | Yes |
| O. | Single Layer | Single Layer | Yes | Yes |
| P. | Single Layer | Single Layer | Yes | No |

Polymeric Film Thickness

As discussed above, the various walls of the flexible bags disclosed herein comprise one or more polymeric films and, in various embodiments, each polymeric film may be a single-layer film or a multi-layer laminated structure. In embodiments, the thickness of the polymeric film can range of from about 25 μm to about 100 μm. Stated differently, the thickness of the polymeric can be in a range defined by any two numbers including the endpoints of such range, selected from the following number, in μm: 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, and 100.

### Non-oxidizing, Inert, and Substantially Inert Materials

The non-oxidizing, inert, or substantially inert material, such as a liquid or gas may comprise a variety of materials that, in some example embodiments, comprise about, or no more than, 10% oxygen. In some embodiments, the oxygen concentration of the non-oxidizing, inert, or substantially inert material is in the range defined by any two numbers given below, including the endpoints of such range: 0.0, 0.05, 0.1, 0.15, 0.2, 0.25, 0.3, 0.35, 0.4, 0.45, 0.5, 1.0, 1.5, 2.0, 2.5, 3.0, 3.5, 4.0, 4.5, 5, 5.5, 6.0, 6.5, 7.0, 7.5, 8.0, 8.5, 9.0, 9.5, and 10. Accordingly, the disclosure in some example embodiments may comprise non-oxidizing, inert, or substantially inert material in a concentration of, for example, 10% or less, a range of 2.0-5.0%, a range of 0.05-0.5%, or a concentration of about 0.1%.

In embodiments, the non-oxygen portion of the non-oxidizing, inert, or substantially inert material, added as a liquid or gas, can comprise inert or non-oxidizing components such as for example, nitrogen, argon, helium, neon, krypton, xenon, carbon dioxide or a combination thereof. In some example embodiments the component may be added in a way that purges existing air that is incorporated during bag manufacturing. The purging may comprise any system and method that is effective to reduce or remove the air (i.e., ambient atmosphere during manufacture) and may include adding gas or liquid comprising the non-oxidizing, inert, or substantially inert material in amounts that replace a portion (e.g., to reduce the amount of oxygen to 10% or less) of air in the flexible bag, and may be performed on flexible bags that are pre-filled, filled, or during the filling process. In some embodiments, the method may comprise applying a vacuum or partial vacuum (reduced pressure) to the flexible bag in order to remove any atmosphere in the bag or bag cavities, and add the non-oxidizing, inert, or substantially inert material at an atmospheric pressure which may replace all or substantially all the atmosphere that does not initially comprise the non-oxidizing, inert, or substantially inert material.

In some embodiments, the non-oxidizing, inert, or substantially inert material, can added as a liquid (e.g., small droplets of liquid nitrogen) to the one or more cavities prior to, or after, filling a cavity with a food product. In such embodiments, the methods may comprise adding an amount of liquid (e.g., liquid nitrogen) to a cavity, wherein the amount is adequate to allow for the liquid to rapidly boil off and expand to a gaseous state that displaces any oxygen-containing atmosphere present prior to the addition. While the amount added may vary depending on bag size and the nature of any product already contained in the bag, embodiments provide for the addition of less than a gram of liquid material (e.g., 1.0 g, 0.9 g, 0.8 g, 0.7 g, 0.6 g, 0.5 g, 0.4 g, 0.3 g, 0.2 g, or 0.1 g or less). In some embodiments, an additional amount of inert material may be added in gas form immediately prior to sealing the packaged product in the flexible bag (e.g., a blanket or top layer). In some embodiments, liquid added to the cavity may be added in a way that the liquid does not make direct contact with the film that forms the cavity wall. For example, in such embodiments, a non-reactive material (material that does not react or decompose when it contacts the non-oxidizing, inert, or substantially inert material) may be added to the cavity such that the liquid inert material comes in contact with the non-reactive material and converts from liquid to gas, which gas fills the cavity. Once the desired amount of the non-oxidizing, inert, or substantially inert material is added, the non-reactive material may be withdrawn from the cavity prior to sealing.

In some embodiments, the non-oxidizing, inert, or substantially inert material may be a combination of such materials, some of which may be included in trace or negligible (i.e., non-measurable or non-accounted for) amounts, as long as the total concentration of the component(s) comprises at least about: 90, 90.5, 91.0, 91.5, 92.0, 92.5, 93.0, 93.5, 94.0, 94.5, 95.0, 95.5, 96.0, 96.5, 97.0, 97.5, 98.0, 98.5, 99.0, 99.1, 99.2, 99.3, 99.4, 99.5, 99.55, 99.60, 99.65, 99.70, 99.75, 99.80, 99.85, 99.90, 99.95, and 100.0. Thus, in some example embodiments, the non-oxidizing, inert, or substantially inert material can comprise nitrogen (as liquid or gas), helium, or argon, or a combination thereof, in a total concentration of at least about 90% (e.g., a range of 92.0-95.0%, for example). In some embodiments, the non-oxidizing, inert, or substantially inert material may comprise nitrogen that can be added as highly purified nitrogen (e.g., at concentrations of greater than 99% such as, for example, about 99.95 or 99.998%). Thus, in some embodiments, concentrations of the material may be added as high purity materials as certain inert and non-oxidizing materials can be provided as a highly purified liquid or gas (e.g., nitrogen). These high purity materials may allow for embodiments that achieve a near complete substitution of air with high concentrations of inert material. As discussed throughout the disclosure, the concentration range of the non-oxidizing, inert, or substantially inert material fall within and be defined by any two numbers recited above, including the numbers as endpoints of such a range.

Polymeric Film

As discussed with reference to aspects and embodiments relating to flexible bags, the polymeric film used to construct the various layers and plys of the flexible bag can comprise is a single-layer or a multi-layer laminate. One or more polymeric films form each wall of the flexible bag. In embodiments wherein more than one polymeric film (i.e., more than one single- or multi-layer polymeric film laminate) comprises each wall, they may form cavities between two polymeric films. These cavities can be filled with non-oxidizing, inert, or substantially inert material (e.g., substantially inert nitrogen added as liquid or gas). In some example embodiments, the polymeric films may comprise a polyethylene (PE). Some exemplary polymeric layers may comprise low density polyethylene (LDPE), linear low-density polyethylene (LLDPE), and/or LLDPE copolymers. These polymers are generally commercially available and are known in the art. Some non-limiting example embodiments of such polymers are described in more detail herein. In some particular embodiments, a polymeric film comprises low density polyethylene (LDPE), linear low-density polyethylene (LLDPE), and/or LLDPE copolymers.

### LDPE

As used herein, “LDPE” refers to low-density polyethylene. Generally, “low-density” refers to polyethylenes having a density in a range of 0.918-0.930 g/cm³. Typically, LDPE molecules have complex branching patterns, with no easily distinguishable backbone. The polymer molecules comprise a network of side chain branches of various lengths including those that may be characterized as short and those that may be characterized as long (e.g., at least relative to each other). The LDPE can be the high-pressure, low-density polyethylene, or HP-LDPE, which is relatively high in average molecular weight and may have, in some embodiments, a low melt-index (e.g., 0.1-1.1 dg/min).

In one embodiment, the LDPE can be added at up to 30% by weight of the polymer blend of the polymeric film. That is, embodiments provide for the weight percent of LDPE in the polymer blend of the polymeric film that can be any one of the following numbers measured in %, or in a range defined by any of the two numbers, including the endpoints of such range: 0; 1; 2; 3; 4; 5; 6; 7; 8; 9; 10; 11; 12; 13; 14; 15; 16; 17; 18; 19; 20; 21; 22; 23; 24; 25; 26; 27; 28; 29; and 30%.

In some embodiments, the LDPE weight content is from 10-15% of the polymer blend in the polymeric film. Some embodiments comprise LDPE having an MI between 0.25-1 dg/min and a density of 0.918-0.925 g/cm³. Some commercially available LDPEs can exhibit these characteristics including, for example, Dow 611A, having a density of 0.924 g/cm³ and an MI of 0.88. Other LDPEs such as, for example, Dow 132i with an MI of 0.25 and a density of 0.921 g/cm³ fall within these physical parameters and fall within the example embodiments disclosed herein.

### Ethylene-α-Olefin Copolymer (EAO Copolymer)

The disclosure provides an EAO copolymer that may be used within the scope of the various aspects and embodiments described herein, and may comprise, for example, ethylene-C4 to C10-α-olefin interpolymer. In some embodiments, the ethylene-C4 to C10-α-olefin interpolymer or EAO copolymer has a melt index of from 0.4 to 1.5 dg/min (g/10 min; 190° C., 2.16 kg); a density of from 0.900 to 0.916 g/cm³ and may be a single polymer, or a blend of two polymers, or comprise several different individual polymer grades. As used herein, an “interpolymer” encompasses copolymers, terpolymers, and the like.

The EAO copolymer may be selected from linear, low-density polyethylenes (LLDPEs). Using industry convention, linear, low-density polyethylenes in the density range 0.915-0.930 g/cm³ may be referred to as LLDPEs, and those in the density range of 0.900-0.915 g/cm³ may be referred to as ultra-low-density polyethylenes (ULDPEs) or very low-density polyethylenes (VLDPEs).

Heterogeneously branched ULDPE and LLDPE are generally known in the art (e.g., technologies associated with linear polyethylenes). They may be prepared by known methods, including those using Ziegler-Natta solution, slurry or gas phase polymerization processes and coordination metal catalysts as described, for example, by Anderson, et al. in U.S. Pat. No. 4,076,698 (incorporated herein by reference). The Ziegler-type linear polyethylenes are not homogeneously branched and they do not have any long-chain branching. At a density less than 0.90 g/cm³, these materials are very difficult to prepare using conventional Ziegler-Natta catalysis and are also very difficult to pelletize. The pellets are tacky and tend to clump together. Companies such as Dow, Nova, and Huntsman produce suitable, commercially available interpolymers (including, for example, DOWLEX™, SCLAIR™ AND REXELL™, respectively) using a solution phase process. Other companies such as ExxonMobil, ChevronPhillips and Nova produce suitable, commercially available interpolymers (including, for example, NTX™, MARFLEX™ LLDPE, NOVAPOL™ LLDPE, respectively) using a gas phase process, or a slurry process (e.g., MARFLEX™ LLDPE). In example embodiments, one or more of these polymers can be used as a blend component of the inner-ply film layer.

Homogeneously branched ULDPEs and LLDPEs are also known in the art (see, e.g., U.S. Pat. No. 3,645,992, incorporated herein by reference). They can be prepared in solution, slurry or gas phase processes using single site catalyst systems. For example, Ewen, et al., in U.S. Pat. No. 4,937,299 (incorporated herein by reference), describe a method of preparation using a metallocene version of a single site catalyst. These polymers are commercially available, and sold by ExxonMobil Chemical under the trademark Exact® and by Dow Chemical under the trademark Affinity® and by Nova Chemical under the trademark Surpass®.

The term “homogeneously-branched” as used herein can refer to (1) the α-olefin monomer being randomly distributed within a given molecule, (2) substantially all of the interpolymer molecules having the same ethylene-to α-olefin monomer ratio, and (3) the interpolymer having a narrow short chain branching distribution. The short chain branching distribution index (SCBDI) refers to the weight percent of the polymer molecules having a co-monomer content within 50 percent of the median total molar co-monomer content. The short chain branching distribution index of polyolefins that are crystallizable from solutions can be determined by known temperature rising elution fractionation techniques, such as those described by Wild, et al., Journal of Polymer Science, Poly. Phys. Ed., Vol. 20, p. 441 (1982), L. D. Cady, “The Role of Comonomer Type and Distribution in LLDPE Product Performance,” SPE Regional Technical Conference, Quaker Square Hilton, Akron, Ohio, October 1-2, pp. 107-119 (1985), or U.S. Pat. No. 4,798,081 (each incorporated herein by reference in the entirety).

Example embodiments of the disclosure relate to C4 to C10-α-olefin linear low-density polyethylenes, including, for example, 1-octene, 1-hexene, 1-butene, or mixtures thereof, and in certain example embodiments the α-olefin is 1-octene.

In some embodiments the EAO copolymer is up to 40% butene-LLDPE polymer in the density range of from about 0.818 to about 0.922 g/cm³.

As described above, LLDPE copolymers include LLDPE copolymerized with any one or more of butene, hexene and octene, metallocene LLDPE (mLLDPE) or metallocene plastomers, metallocene elastomers, high density polyethylene (HDPE), rubber modified LDPE, rubber modified LLDPE, acid copolymers, polystyrene, cyclic polyolefins, ethylene vinyl acetate (EVA), ethylene acrylic acid (EAA), ionomers, terpolymers, Barex, polypropylene, bimodal resins, any of which may be from either homopolymers or copolymers, and blends, combinations, laminates, micro-layered, nanolayered, and coextrusions thereof. Polyolefins can be manufactured using Ziegler-Natta catalysts, chromium catalysts, metallocene-based catalysts, single-site catalysts and other types of catalysts. The materials can be bio-based, petro-based and recycled/reground.

Many types of polymers, interpolymers, copolymers, terpolymers, etc. are described in the art and may comprise the polymeric film forming one or more of the layers of the flexible bag in the example embodiments in accordance with the disclosure. Non-limiting examples of patents that describe such polymers include U.S. Pat. Nos. 4,503,102; 4,521,437; and 5,288,531. These patents describe films used to make pouches, which films may also be used to make bags. Other patent references that describe skin layer polymers include U.S. Pat. Nos. 8,211,533; 8,252,397; 8,563,102; 9,757,926; 9,283,736; and 8,978,346. All these patent documents are incorporated herein by reference.

The thickness of the polymeric film is in the range of 25 μm to 100 μm. Thus, in embodiments, the thickness of the sealant layer can be any number selected from the following (in μm): 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, and 100. In some embodiments, the thickness of the polymeric film can be in the range defined by any two numbers selected from the numbers delineated above, including the end-points of such range.

### Flexible Bag Construction

The wall of said flexible bag made from a laminate of flexible materials. In one embodiment, the laminate comprises: (A) an FCR-improving layer; (B) an OTR-reducing barrier layer; and (C) a sealant layer. In some embodiments the laminate may comprise further layers (e.g., additional layers that may be made of materials similar to the sealant layer, tie layers, adhesives/resins, etc.).

### Sealant Layer

As used herein, the term “sealant layer” refers to a layer of a laminate of flexible material, wherein the material is configured to be sealed to itself or another sealable layer using any kind of sealing method known in the art, including, for example, heat sealing (e.g. conductive sealing, impulse sealing, ultrasonic sealing, etc.), welding, crimping, bonding, and the like, and combinations of any of these. Exemplary embodiments of a sealant layer comprises low density polyethylene (LDPE), linear low-density polyethylene (LLDPE), and/or LLDPE copolymers. In some embodiments, the sealant layer comprises LDPE, and in further embodiments, the sealant layer comprises LLDPE. In some embodiments the sealant layer may comprise a layer that comprising one or more EAO copolymers as generally known in the art and as disclosed herein.

In some example embodiments falling within the scope of the disclosure, a sealant film for use in a film structure suitable for a flexible bag (e.g., that can contain flowable materials) as disclosed herein, may comprise:

(1) from about 2.0 to about 9.5 wt. %, based on 100 wt. % total composition, of an ethylene C4-C10-alpha-olefin interpolymer having a density of from 0.850 to 0.890 g/cm³ and a melt index of 0.3 to 5 dg/min, the interpolymer being present in an amount such that the film structure develops 10 or less pinholes per 300 cm² in 20,000 cycles of Gelbo Flex testing, as measured using a Gelbo Flex tester set up to test in accordance with ASTM F392, and has a thermal resistance at temperatures just above 100° C., as measured using DSC (ASTM E794/E793) Differential Scanning calorimetry (DSC) which determines temperature and heat flow associated with material transitions as a function of time and temperature, and a minimum tensile modulus of 20,000 psi as measured using Tensile Modulus of the polyethylene films measured in accordance with ASTM Method D882;

(2) from about 70.5 wt. % to about 98.0 wt. %, based on 100 wt. % total composition, of one or more polymers selected from ethylene homopolymers and ethylene C4-C10-alpha-olefin interpolymers, having a density between 0.915 g/cm³ and 0.935 g/cm³ and a melt index of 0.2 to 2 dg/min;

(3) from about 0 wt. % to about 20.0 wt. %, based on 100 wt. % total composition, of processing additives selected from slip agents, anti-block agents, colorants and processing aids; and the sealant film has a thickness of from about 5 μm to about 60 μm.

In some embodiments the disclosure provides a multi-layer ply, wherein the outer layer of the multi-layer ply comprises ethylene-vinyl alcohol coextrusion; a middle layer comprises metallized biaxial nylon; and the sealant layer comprises LLDPE. In such embodiments, the thickness of the sealant layer may be in the range of from about 25 μm to about 100 μm (e.g., the thickness may be any one of 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, and 100 μm). The thickness of the sealant layer can be in the range defined by any two numbers selected from the numbers delineated above, including the end-points of such range.

Generally, in some embodiments of the disclosure, the orientation of a multi-layer flexible bag, the sealant layer is on the outside and further away from the product to be packaged in the flexible bag. The FCR-improving layer is on the inside and proximate to the ingredient to be packaged in the flexible bag. The OTR-reducing barrier layer is in between the sealant layer and the FCR-improving layer. In further embodiments, as described throughout the disclosure, other polymeric layers with other functionalities may be included in the flexible bag structure, such as, for example, interposed in between the FCR-improving layer and the OTR reducing barrier layer, and/or in between the OTR-reducing layer and the sealant layer, and/or on the interior of the FCR-improving layer or the exterior of the sealant layer.

As noted throughout the description, the resin composition can form one or more layers of a multilayer coextruded film made in a blowing or casting process. Films of the resin composition can also be combined with other layers in processes such as adhesive lamination, thermal lamination, extrusion lamination, extrusion coating and the like.

### FCR-Improving Layer

In one embodiment, the FCR-improving layer can comprise coextruded EVOH (EVOH co-ex) blown film. EVOH is an extrudable resin that has excellent oxygen, flavor, and aroma barrier properties. EVOH resins and packaging materials have been used for several decades as meat and cheese film wrappers and the barrier properties of EVOH with respect to oxygen, grease, oil, flavor additives, and aroma is well understood. EVOH coex holds its oxygen barrier properties (OTR) very well when subjected to flex cracking, or continuous bending. However, under some circumstances and conditions, co-ex EVOH performance can be hindered as an oxygen barrier such as, for example, at varying levels of humidity. Flex-cracking would typically occur during the bag manufacture process and can also be experienced during transportation of the filled bags.

The EVOH co-ex can comprise 3, 5, 7, 9, or 12 layers or even an asymmetric distribution of co-extruded layers. A non-limiting example of EVOH coextrusion is a ply or layer comprising polyethylene/tie layer/ethylene vinyl alcohol/tie layer/polyethylene.

As noted above, when exposed to certain humidity levels (e.g., 85% or higher), the barrier properties of EVOH may degrade. To avoid the degradation, the EVOH is typically extruded in a multi-layer symmetrical coextrusion in which specialized tie resins are used to adhere the EVOH to outer polyolefin layers that protect the EVOH from humidity. For example, in some embodiments the disclosure relates to a three resin, five-layer coextrusion of EVOH may include LDPE-Tie layer-EVOH-Tie layer-LDPE. In this five-layer structure, the LDPE (low density polyethylene) layers protect the EVOH layer from exposure to moisture. Also, the LDPE and tie-layer are extruded each from one extruder where they are split into two layers and directed to either side of the EVOH layer by a feed-block device. The LDPE and Tie layer are the same material on both sides of the EVOH, thus it is called a symmetrical coextrusion. But even with the multilayer construction, under high relative humidity, for example 90% or 95% or greater, EVOH degrades.

The thickness of the FCR layer is in the range of from about 25 μm to about 100 μm. Stated differently, the thickness of the FCR layer can be any number from the following number in μm: 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, and 100. The thickness of the FCR layer can be in the range defined by any two numbers selected from the numbers delineated above, including the end-points of such range.

OTR-Reducing Barrier Layer

The polymeric materials contemplated as the OTR-reducing barrier layer include any polymeric film oriented or unoriented which includes polymeric or copolymeric PET or PA. PET is polyethylene terephthalate and PA is polyamide or Nylon. The polymeric film is metallized, for example, metallized, PET or metallized PA. In some embodiments, such films are made from polypropylene or PLA (polylactic acid) or PVOH.

In one embodiment, this OTR layer comprises metallized polyester (Met-PET) or metallized bi-axially oriented polyamide layer (Met-BoPA). Depending on the grades chosen, one can get very good barrier that is not affected by changes in relative humidity. However, the oxygen barrier properties do not stand up very well to flex cracking. By combining both the EVOH for its great flex durability and Met-PET or Met-BoPA, for their resistance against varying relative humidity, one can realize both benefits and create a barrier film that allows for the oxygen barrier properties to be affected minimally during normal application.

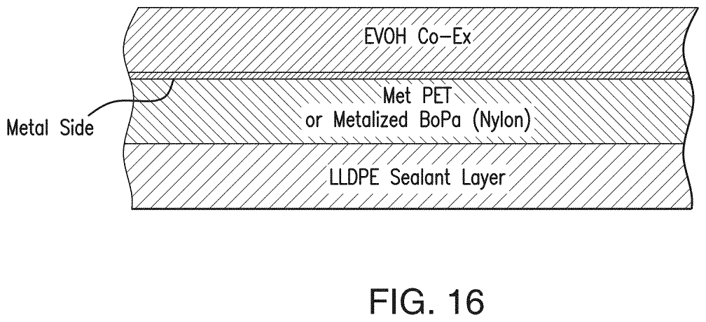

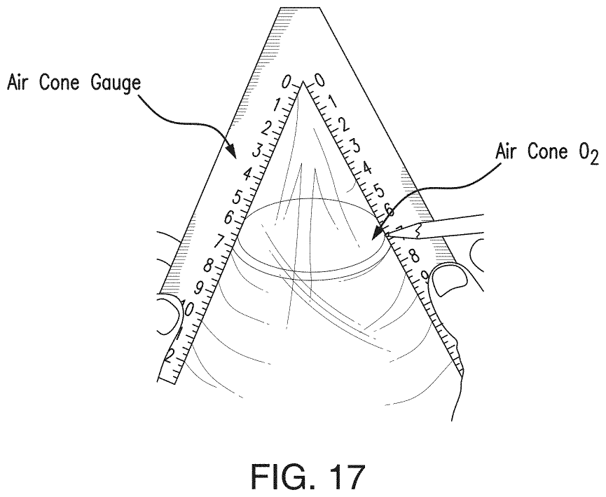

During high and varying relative humidity, the oxygen barrier properties of the EVOH co-ex may be compromised. Traces of oxygen will pass through the EVOH co-ex, but will “bounce off” and not permeate through the metallized layer on the PET or BoPA. The metallized layer will act as the OTR barrier in this high relative-humidity application. This is depicted, for example, in FIG. 16.

During high levels of flex cracking, the metallized layer could be compromised and the EVOH coex protects the construction from oxygen ingress. By engineering a laminated structure that is not affected by relative humidity, one can control and closely predict the amount of oxygen that passes through the packaging material.

The thickness of the OTR layer is in the range of 25 μm to 100 μm. Stated differently, the thickness of the OTR layer can be any number from the following number in μm: 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, and 100. In embodiments, the thickness of the OTR layer can be in the range defined by any two numbers selected from the numbers delineated above, including the end-points of such range.

### Other Ingredients

The present blends may include additional ingredients as processing aids, anti-oxidation agents, UV light stabilizers, pigments, fillers, compatibilizers or coupling agents and other additives that do not affect the essential features of the aspects and embodiments described herein. They may be selected from processing masterbatches, colorant masterbatches, at least one low-density ethylene homopolymer, copolymer or interpolymer which is different from component the EAO copolymer of the component (b) of the present blend, at least one polymer selected from the group comprising EVA, EMA, EM, at least one polypropylene homopolymer or polypropylene interpolymer also different from component (b) of the present blend. The processing additives generally referred to, as “masterbatches” comprise special formulations that can be obtained commercially for various processing purposes.

Alternatives to any of these commercially available products would be selectable by a person skilled in the art for the present purposes. The resin blend defined above is selected to ensure that the resulting film has the characteristics defined. Other components, as subsequently described may be added to the blend so long as they do not negatively impact on the desired characteristics of the film disclosed herein.

### Process for Preparing Flexible-Bags

In one aspect the disclosure provides a process that effectively removes all gases that form or accumulate within the different layers of a flexible-bag and replaces it with non-oxidizing, inert, or substantially inert material (gas), (e.g., nitrogen gas), effectively “flushing” the bag during the manufacturing process and sealing the material inside the flexible-bag cavities.

This additional step eliminates the air comprising of oxygen accumulated in the cavities of a multilayered bag. The replacement with non-oxidizing, inert, or substantially inert material may be performed during the continuous bag-making process, and prior to the filling of the bags with a product, for example, wine. The non-oxidizing, inert, or substantially inert material may be introduced in between the different layers that make up the flexible bag, at the same time as the bag is being manufactured.

In one embodiment, the non-oxidizing, inert, or substantially inert material, such as nitrogen, may be introduced just before the side seal and/or long seal formation in the flexible-bag-in-box manufacturing line. The side seal/long seal unit effectively makes a tube that acts like a vessel. In the process provided herein, the tube or the vessel is introduced with non-oxidizing, inert, or substantially inert material (e.g., gas), for example, under pressure that displaces the air including the oxygen in the air. The process of the disclosure also removes all the air trapped in between the different layers that make up the bag, forcing it out of the only open cavity which is the open end of the tube.

In one embodiment, a sweep or brush pushing down on a plate or roller, trapping the different film layers making the bag, is then used to drive out any residual non-oxidizing, inert, or substantially inert material, (e.g., any inert gas), from the bag before the cross seal/final seal of the bag is made. The final product is a flexible-bag that has an amount of non-oxidizing, inert, or substantially inert material occupying the open cavities between the film layers and not air comprising oxygen.

### Process for Making a Three-Cavity Bag

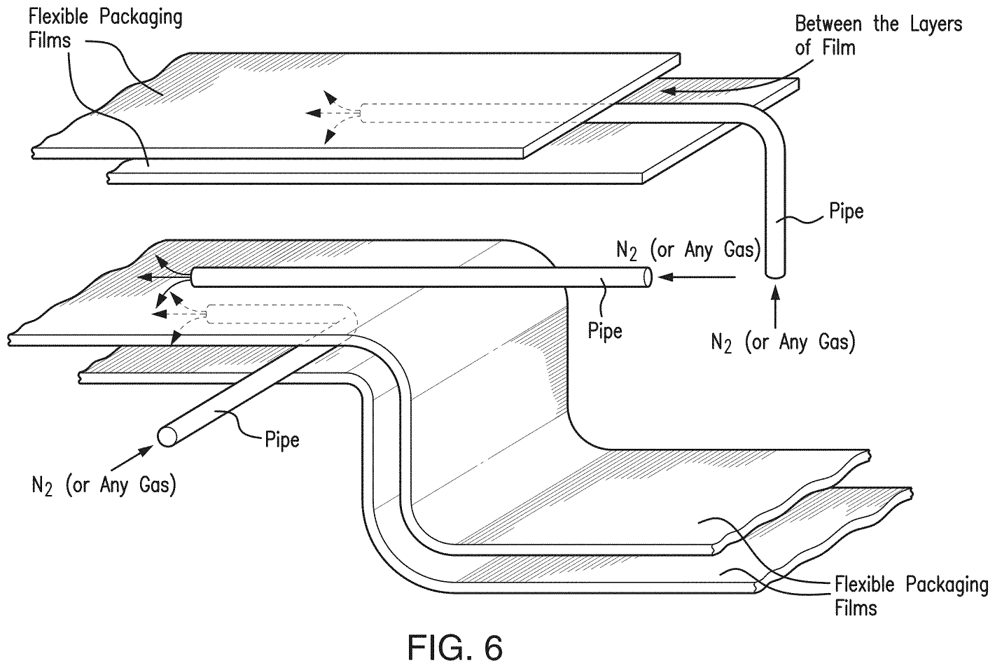

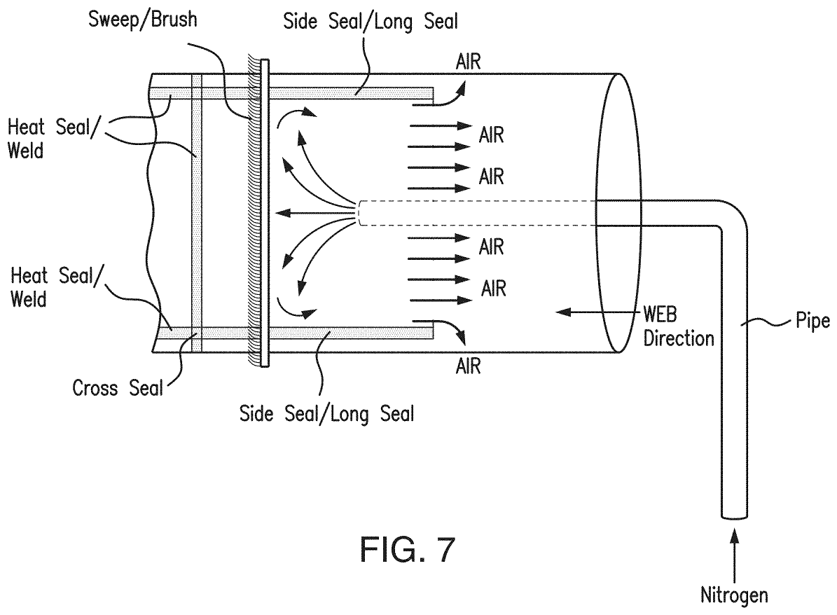

FIGS. 6 and 7 show a process for preparing a flexible bag, comprising: introducing non-oxidizing, inert, or substantially inert material, such as nitrogen, in the first cavity of the three cavity bag through a first main-tube connected to an external gas source; introducing the material through a second main-tube into the second cavity; and introducing the material into the third cavity through a third main-tube; from an source during the continuous process of flexible bag-making. The material (e.g., inert gas) replaces, substantially, all air in the three cavities with the material. The three cavities are sealed at the edges or the perimeter, which is followed by a sweeping or burping to remove as much air/nitrogen in between the cavities as possible. These steps may be repeated for preparing the next flexible bag in the continuous or even a stop-and-start process of flexible-bag-making.

The introduction of material (e.g., inert gas such as nitrogen) does not consume time that slows down the bagmaking speed in any significant fashion, if at all.

In one embodiment, the material introduced comprises a gas from an external gas source comprising at least one of nitrogen, argon, helium, or a combination thereof. In one embodiment, the material comprises inert gas comprising nitrogen.

In one embodiment, the main tube introducing non-oxidizing, inert, or substantially inert material (or air) into the cavities is a simple tube. In another embodiment, the main tube comprises multiple inlet ports. In another embodiment, the multiple inlet ports are located at the ends of multiple sub-tubes emanating from said at least one main tube, and wherein said multiple sub-tubes are of various lengths. In another embodiment, the multiple-sub-tubes are organized in a gradually-increasing-in-length or a gradually-decreasing-in-length fashion. In yet another embodiment, the non-oxidizing, inert, or substantially inert material (e.g., inert gas) is introduced into the cavities is in a turbulent flow. In a further embodiment, the turbulent flow creates a circular flow of the material that displaces the air in one or more cavities. This turbulent flow is created as a result of high pressure of material (inert gas) or as a result of differential pressure due to different lengths of sub-tubes introducing the inert gas into the cavities. This disclosure also provides embodiments wherein one or two or all three cavities have circular flow created by turbulent flow.

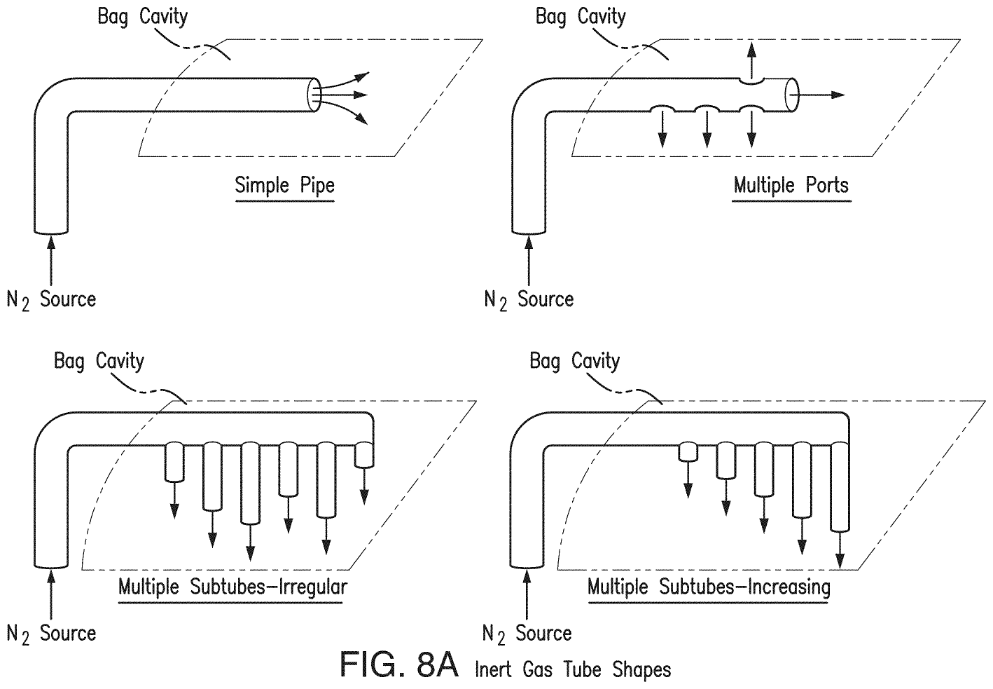

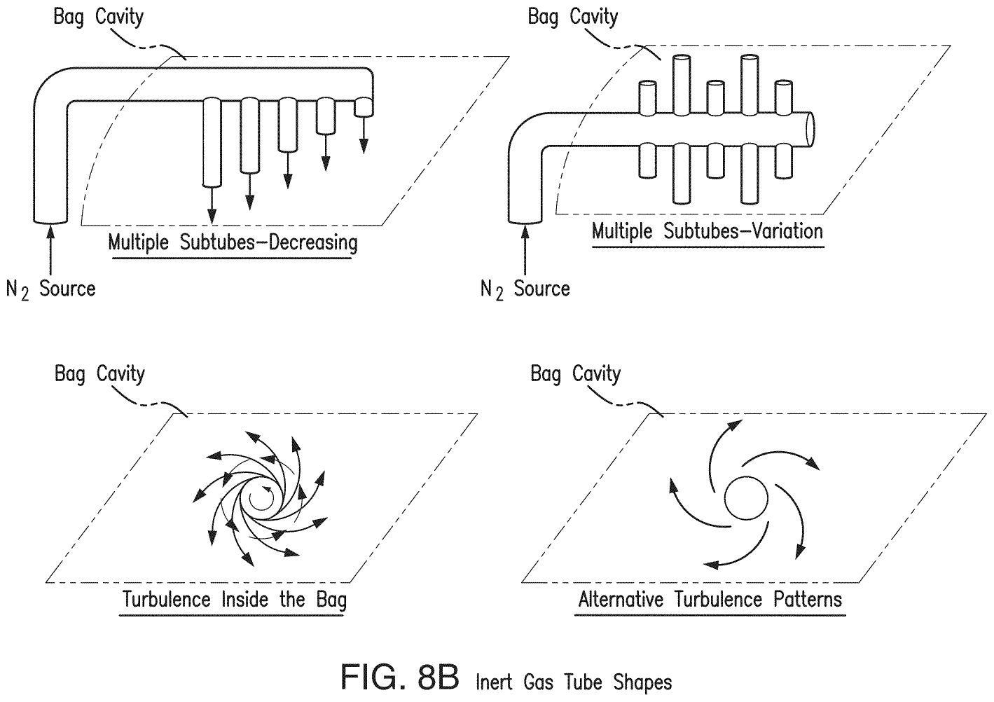

In further embodiments, the non-oxidizing, inert, or substantially inert material comprising a liquid, and thus, the method comprises adding an amount of material as a liquid, which can expand and convert to gas under typical manufacturing conditions (e.g., liquid nitrogen “boils” to convert and expands to gas form). The disclosure also encompasses embodiment where one, two, or all three cavities have the air replaced by non-oxidizing, inert, or substantially inert material, such as nitrogen. FIG. 8 shows the various embodiments of the disclosure described above.

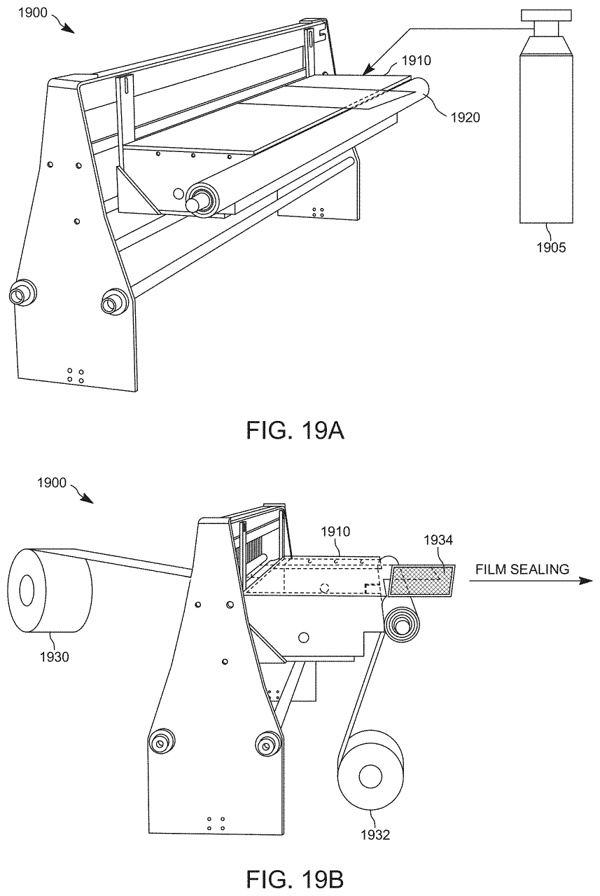

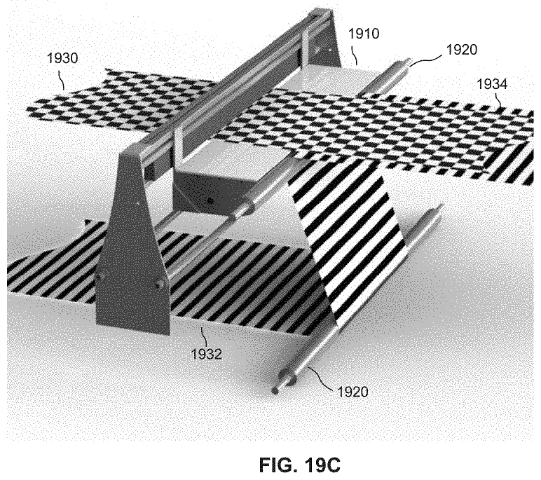

In another aspect, the disclosure provides a device that can be used in the manufacture of the flexible bags disclosed throughout the description. For example, FIGS. 19A and 19B depict two views of an example embodiment of a device provided by the disclosure. A chamber or fillable structure (1910) is attached to a film roller apparatus (1900) used in bag-making, where the chamber (1910) can be connected to a source (1905) of, and filled with an amount of, the non-oxidizing, inert, or substantially inert material, whether as a gas under positive pressure or as a liquid that may convert to a gas atmosphere within the chamber. Referring to FIG. 19B, the chamber (1910) is positioned with respect to at least one of the films (1930) that forms the flexible bag such that the film(s) are exposed to the inert material in the chamber immediately prior to layering to at least one other film (1932), forming the bag and cavity or cavities (1934) filled with inert material prior to sealing. In a processing line, one or more of the film(s) (1930, 1932) comprising the flexible bag may be positioned and moved by rollers (1920) such that the film(s) (1930) pass over the chamber (1910), drawing off at least some amount of the non-oxidizing, inert, or substantially inert material (1905) which is subsequently layered on to one or more sheets of film (1932) prior to film sealing.

Similarly FIG. 19C, depicts an arrangement of the device with associated rollers (1920) guiding one or more films (1930, 1932) that are drawn from remotely positioned film reels, and which may pass over the chamber (1910) containing an amount of inert material. As the film(s) pass over the chamber and layer on one or more additional films, the volume between the film layers contains the inert material (e.g., trapped or contained between films) immediately prior to sealing to form one or more cavities. As described above, the processing line may comprise one or more films (1930, 1932) that may be positioned and moved by one or more rollers (1920) such that the film(s) pass over the chamber (1910), drawing off at least some amount of the non-oxidizing, inert, or substantially inert material that is trapped between film layers prior to film sealing.

The three-cavity bag is described above. The same process applies for flexible bags having a structure that comprises a plurality of cavities (i.e., 3 or more than 3 cavities, including for example 4, 5, 6, 7, 8, 9, or 10 or more cavities), which typically comprises a greater number of polymeric films that form cavities between any two of the films. In some example embodiments, a flexible bag can comprise 5, 7, or 9 cavities. The same process can apply to embodiments that provide a single-cavity flexible bag, where the only cavity in which the product, such as wine, will be eventually packaged, has the air inside replaced with inert material (e.g., gas such as nitrogen). The previous embodiments described in context of the manufacture of three-cavity flexible bags apply to the multiple-cavity bag and the single-cavity bag.

In some aspects, the disclosure provides an improved bag-making process comprising providing a multi-ply film structure, having inner and outer plies, wherein at least one of the plies is a film described herein, securing a spout to inner and outer plies of the film structure through a hole provided therein, sealing the plies together transversely across the width of the multi-ply film structure, to form a top seal of one bag and a bottom seal of the bag and a top seal of an adjacent bag, then sealing the plies together parallel to the length of the bag line are applied at either side of the films, and trapped air being removed prior to completely sealing the bag, and separating the bags immediately or just prior to use.

In one embodiment, an F-S-F machine is used for making the flexible bags. In this machine, the bag is formed and sealed. Then it is filled with product later, and not continuously during formation. In the first step, one, two, or another suitable number of reels of film unwind. A hole can be cut in the top layer and a spout and tap assembly (fitment) is positioned and sealed. The perimeter of the bag may be sealed. The finished bag can be cut and separated. The bag may be optionally transferred to a rotary filler. The bag may be filled and loaded into a carton. Alternatively, sealed and closed (fitment) bags can be supplied to the filler who fills the flexible bags with food product such as wine. The F-S-F machine is from the Flextainer Co. In the F-S-F model, the film and the fitments may be supplied to an off-site (i.e., customer site) filling center.

In various aspects, the disclosure relates to providing a film described herein for making a bulk bag, wherein said film forms the inner-ply of the multi-ply bag. Bag-making process is described generally in U.S. Pat. No. 8,211,533, which is incorporated by reference herein.

Bags Filled with Flowable Materials

In one aspect, the disclosure relates to bags described above, filled with flowable materials. Examples include bags filled with flowable materials such as water, beverages, juices, coffee, tea, energy drinks, beer, wine, sauces, mustard, ketchup, food dressings, milk, cheese, sour-cream, mayonnaise, salad dressings, relish, oils, soft margarine, coffee concentrate, pastes, puree, ice cream mix, milk shake mix, preserves, emulsions, doughnut fillings, jellies, detergents, caulking materials, medicines, materials used in manufacturing, and the like.

### POLYMERIC FILMS—VARIOUS EMBODIMENTS

### Embodiment 1—Thermal Lamination (Hot Roll) Process

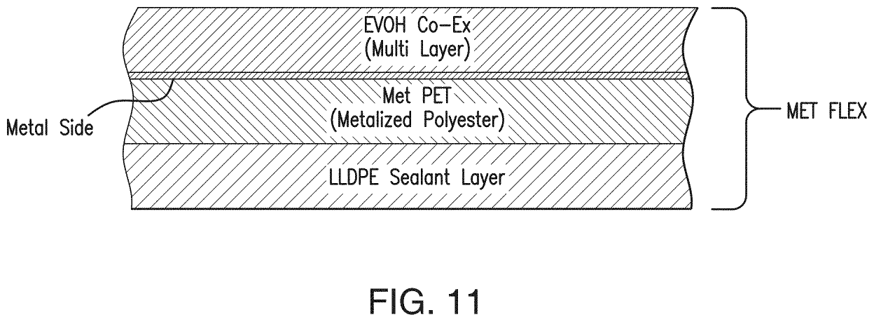

In one embodiment, the film can comprise 3 layers of flexible film: LLDPE sealant layer; metallized polyester (met-PET) OTR-reducing barrier layer; and FCR-improving co-extruded EVOH layer. These layers are thermally laminated together to form 1 structure used in the flexible packaging applications. The selection of the raw materials and the placement in their specific order, add value to the material achieving great results in flex-cracking subjected during transportation, and oxygen transmission rate when exposed to high levels of humidity. As shown in FIG. 11, in this embodiment, the Met-Flex construction is manufactured using the Thermal lamination, (Hot Roll) process. Typical characteristics are:

First Layer: EVOH Coextruded Blown Film
Layer construction: 3, 5, 7, 9, 12; multi-stream using multiplication layer distribution.
Total thickness is 25-100 micron.

Second Layer: Met-PET
10-15 micron metallized polyester.
Total thickness is 25-100 micron.

Third Layer: LLDPE—Sealant layer
Total thickness is 25-100 micron.

### Embodiment 2—Extrusion Lamination/Coating

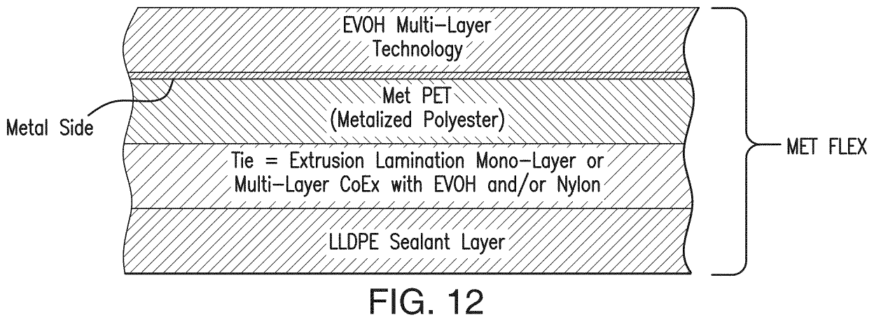

In one embodiment, the film can comprise 4 layers of flexible film: LLDPE sealant layer; a tie layer; metallized polyester (met-PET) OTR-reducing barrier layer; and FCR-improving co-extruded EVOH layer. These layers are thermally laminated together to form a structure used in the flexible packaging applications. As shown in FIG. 12, in this embodiment, the Met-Flex construction is manufactured using the Extrusion Lamination/Coating process. Typical characteristics are:

First Layer: EVOH Extrusion-Coated Coextruded Blown Film
Layer construction: 3, 5, 7, 9, 12; multi-stream using multiplication layer distribution.
Total thickness is 25-100 micron.

Second Layer: Met-PET
10-15 micron metallized polyester, with an oxygen transmitting rate of 0.05 cm3/m2-day to 3 cm3/m2-day.
Total thickness is 25-100 micron.
Metal side is contacts the EVOH layer.

Third Layer: Tie Layer

The tie-layer is made using extrusion lamination, which is a monolayer or a multilayer co-extrusion with EVOH and/or nylon.

Fourth Layer: LLDPE—Sealant layer
Total thickness is 25-100 micron.

### Embodiment 3—Extrusion Lamination/Co-Extrusion Multi-Layer Technology

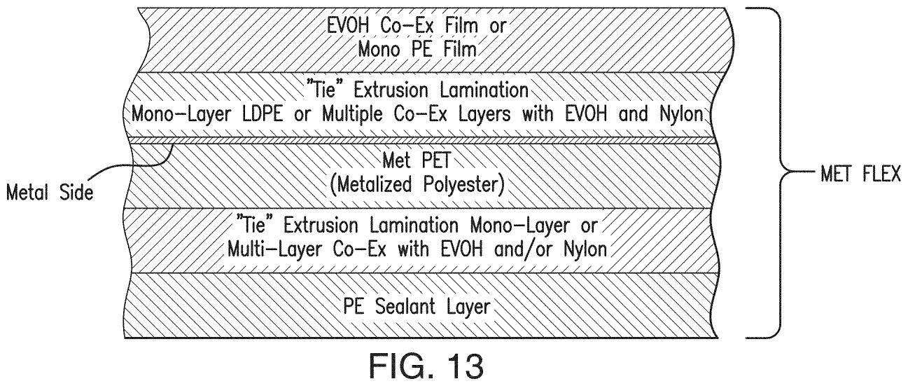

In one embodiment, the film can comprise 5 layers of flexible film: PE sealant layer; a first tie layer; metallized polyester (met-PET) OTR-reducing barrier layer; a second tie layer; and FCR-improving coextruded EVOH layer. These layers are made by extrusion lamination and multi-layer technology to form a structure used in the flexible packaging applications. As shown in FIG. 13, in this embodiment, the Met-Flex construction is manufactured using the Extrusion Lamination/Co-extrusion Multi-Layer Technology. Typical characteristics are:

First Layer: EVOH Extrusion-Coated Coextruded Blown Film or Monolayer PE Film
Layer construction: 3, 5, 7, 9, 12; multi-stream using multiplication layer distribution.
Total thickness is 25-100 micron.

Second Layer: Tie Layer

The tie-layer is made using extrusion lamination, which is a monolayer LDPE or a multilayer co-extrusion with EVOH and/or nylon.

Third Layer: Met-PET
10-15 micron metallized polyester, with an oxygen transmitting rate of 0.05 cm3/m2-day to 3 cm3/m2-day.
Total thickness is 25-100 micron.
Metal side contacts the tie layer.

Fourth Layer: Tie Layer

The tie-layer is made using extrusion lamination, which is a monolayer LDPE or a multilayer co-extrusion with EVOH and/or nylon.

Fifth Layer: LLDPE—Sealant layer

### Embodiment 4—Extrusion Lamination/Thermal Hot Roll Process

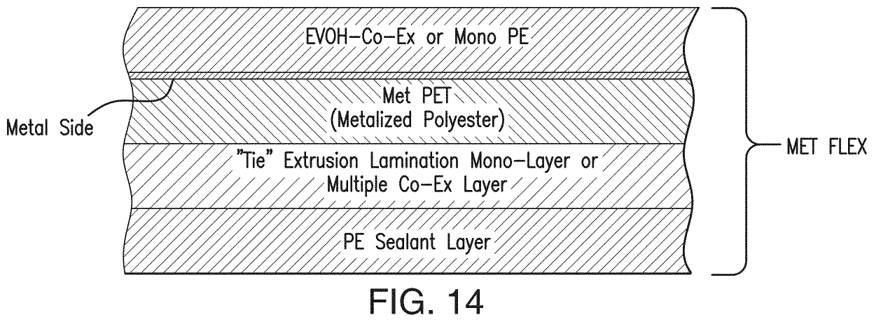

In one embodiment, the film can comprise 4 layers of flexible film: PE sealant layer; a first tie layer; metallized polyester (met-PET) OTR-reducing barrier layer; a second tie layer; and FCR-improving coextruded EVOH layer. These layers are made by extrusion lamination and multi-layer technology to form a structure used in the flexible packaging applications. As shown in FIG. 14, in this embodiment, the Met-Flex construction is manufactured using the Extrusion Lamination/Hot Roll Thermal Lamination. Typical characteristics are:

First Layer: EVOH Extrusion-Coated Coextruded Blown Film or Monolayer PE Film
Layer construction: 3, 5, 7, 9, 12; multi-stream using multiplication layer distribution.
Total thickness is 25-100 micron.

Second Layer: Met-PET
10-15 micron metallized polyester, with an oxygen transmitting rate of 0.05 cm3/m2-day to 3 cm3/m2-day.
Total thickness is 25-100 micron.
Metal side contacts the tie layer.

Third Layer: Tie Layer

The tie-layer is made using extrusion lamination, which is a monolayer LDPE or a multilayer co-extrusion with EVOH and/or nylon.

Fourth Layer: LLDPE—Sealant layer

### Embodiment 5—Adhesive Lamination

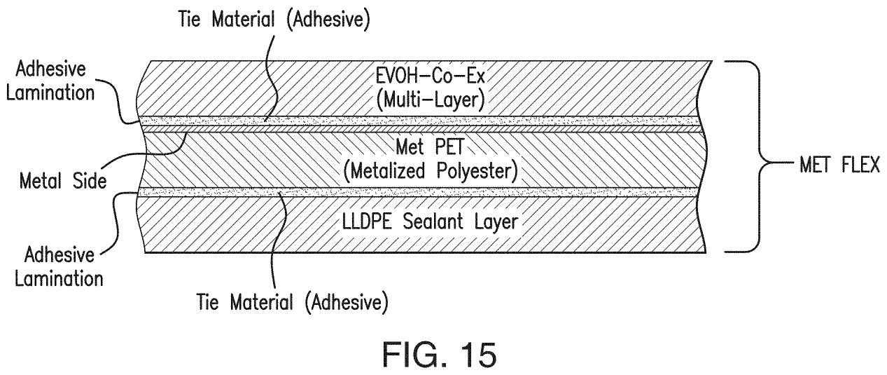

In one embodiment, the film can comprise 3 layers of flexible film: PE sealant layer; metallized polyester (met-PET) OTR-reducing barrier layer; and FCR-improving co-extruded EVOH layer. These layers are made by adhesive lamination to form a structure used in the flexible packaging applications. As shown in FIG. 15, in this embodiment, the Met-Flex construction is manufactured using the Extrusion Lamination/Hot Roll Thermal Lamination. Typical characteristics are:

First Layer: EVOH Extrusion-Coated Coextruded Blown Film or Monolayer PE Film
Layer construction: 3, 5, 7, 9, 12, Multi-stream using multiplication layer distribution.
Total thickness is 25-100 micron.

Second Layer: Met-PET
10-15 micron metallized polyester, with an oxygen transmitting rate of 0.05 cm3/m2-day to 3 cm3/m2-day.
Total thickness is 25-100 micron.
Metal side contacts the sealant layer.

Third Layer: LLDPE—Sealant layer

The three layers adhere to each other using a tie material, an adhesive. A layer of an adhesive, either with solvent or solvent-less, can be used.

Alternatives to any of these commercially available products would be selectable by a person skilled in the art for the present purposes. The resin blend defined above is selected to ensure that the resulting film has the characteristics defined. Other components, as subsequently described may be added to the blend as long as they do not negatively impact on the desired characteristics of the film encompassed by the aspects and example embodiments of the disclosure.

### Other Ingredients

The blends disclosed herein may further include additional ingredients as processing aids, anti-oxidation agents, UV light stabilizers, pigments, fillers, compatibilizers or coupling agents and other additives that do not affect the essential features of the described aspects and embodiments. They may be selected from processing masterbatches, colorant masterbatches, at least one low-density ethylene homopolymer, copolymer or interpolymer which is different from component the EAO copolymer of the component (b) of the present blend, at least one polymer selected from the group comprising EVA, EMA, EM, at least one polypropylene homopolymer or polypropylene interpolymer also different from component (b) of the present blend. The processing additives generally referred to, as “masterbatches” comprise special formulations that can be obtained commercially for various processing purposes.

### Bulk-Bags

Other aspects include bags for containing flowable materials made from the above films. The bags may be irradiated prior to use in accordance with standard procedures well known in the packaging art.

In multi-layer polymeric film, the layers generally adhere to each other over the entire contact surface, either because the polymer layers inherently stick to each other or because an intermediate layer of a suitable adhesive is used. The bags which may be produced from the films are pre-made and then usually filled with food through a fitment. They are often sterilized and may be, for example, irradiated in a batch process, employing standard radiation conditions known in the art. The film may also be sterilized rather than the bags. Sterilization can be achieved in a variety of known ways such as by exposure of the film or bag to hydrogen peroxide solution. The films used to make pouches may be similarly treated prior to package formation. Of importance is that the films and bags can endure aseptic packaging condition.

The bags or pouches using the resin blend compositions described herein can also be surface treated and then printed by using techniques known in the art, e.g., use of corona treatment before printing.

In one embodiment, the disclosure relates to a flexible bag described herein, wherein said bag has a capacity from about 1 L to 400 gallons. For example, the bags may range in size given by any number given below in gallons, or within the range defined by any two numbers given below, including the end-points: 1, 2, 3, 4, 5, 6, 7, 8, 9, 10, 20, 30, 40, 50, 60, 70, 80, 90, 100, 150, 250, 300, 350, or 400.

In some aspects, the capacity of the bags made from the compositions described herein may be sized from about 100 mL to about 8000 mL. For example, the bags may range in size given by any number given below in milliliters (mL), or within the range defined by any two numbers given below, including the end-points: 100, 200, 300, 400, 500, 600, 700, 800, 900, 1000, 1100, 1200, 1300, 1400, 1500, 1600, 1700, 1800, 1900, 2000, 2100, 2200, 2300, 2400, 2500, 2600, 2700, 2800, 2900, 3000, 3500, 4000, 4500, 5000, 5500, 6000, 6500, 7000, 7500, 8000.

The bags are pre-made and then usually filled through a fitment. They are often radiation sterilized in a batch process by the bag manufacturer. The packaging conditions may include those for aseptic packaging.

### Examples

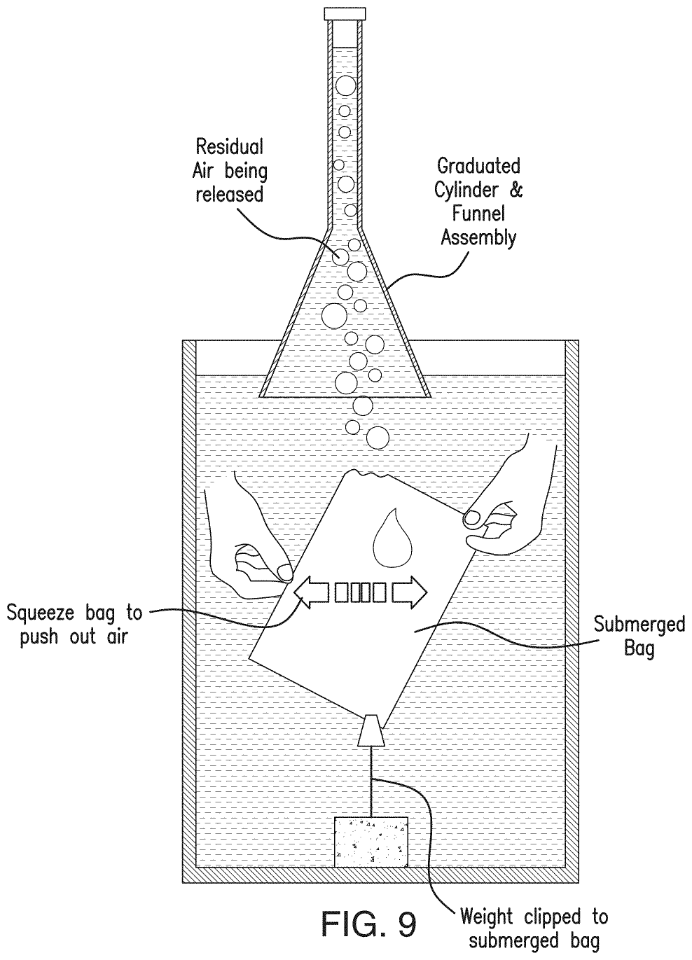

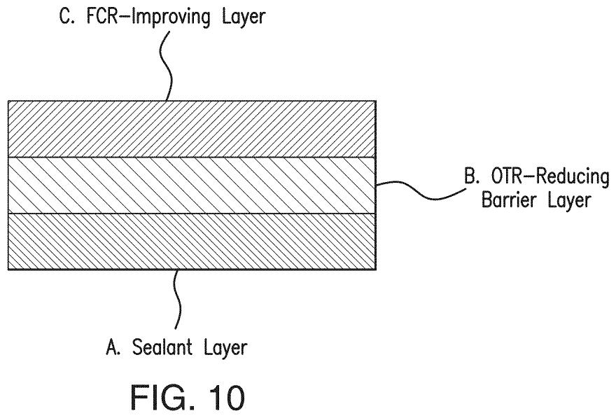

One test that allows for determination of the amount of air trapped in a flexible-bag after manufacture is the Residual Air Test, which is described below and schematically depicted in FIG. 9.

Briefly, a large-sized water-filled container that can fully submerge a bag is provided. The procedure is conveniently used for bags less than 5-gallon filling capacity. A graduated cylinder with an attached funnel is filled with water fully and is placed inverted in a holder over the water ensuring that no air is present in the cylinder, and that the cylinder is filled only with water. A weight is clipped on to a sample flexible-bag and the bag is submerged into the tank. The weight allows for the bag to remain submerged in the water.

For measuring the air between the plies, for example, in a multiple-ply bag, first, the fitment cap or the tap is opened and the air is allowed to escape, but without being captured by the graduated cylinder. Then, the bag is held under the cylinder-funnel assembly, and a bag corner is cut with scissors. All air is squeezed out including that in the spout area but within the multiple plies and is captured in the graduated cylinder.

For measuring the total air trapped in the bag, including in the main cavity or chamber, which is for the filling of the packaged product such as wine, the bag is held under the cylinder-funnel assembly, and a bag corner is cut with scissors. All air is squeezed out including that in the spout area and is captured in the graduated cylinder.

The residual air that is trapped within the funnel assembly is subsequently sampled for oxygen content using a Model 905 Headspace Oxygen Analyzer as supplied by Quantek Instruments. The ZERO setting of the 905 analyzer is set by flushing nitrogen until a stable reading near zero was obtained. The oxygen ZERO adjuster on the machine is tuned until a reading of 0.0% oxygen is obtained. Calibration conditions are 72° F., 55% RH, and elevation of 507 ft. The SPAN setting of the oxygen channel is set by flushing with compressed air until a stable reading is obtained. The SPAN adjuster is tuned until a reading 20.9% oxygen is obtained.

After the N2 replacement, several three-cavity flexible-bags are analyzed using the 905 analyzer to determine the residual oxygen content in the bags (which were edge sealed and closed). A ten-sample average provided a result of 0.24% oxygen in the main cavity. Stated another way, from a residual air having about 20.47% oxygen, the inert gas replacement now produced bags that have only 0.24% oxygen in all cavities.

TABLE 2
Oxygen Content in %

| | Middle Cavity |
|---|---|
| Sample No. | Oxygen Content % |
| 1. | 0.21 |
| 2. | 0.21 |
| 3. | 0.20 |
| 4. | 0.26 |
| 5. | 0.26 |
| 6. | 0.23 |
| 7. | 0.23 |
| 8. | 0.15 |
| 9. | 0.33 |
| 10 | 0.36 |
| Average | 0.24 |

Headspace inside the cone of the bag is calculated according to the following formula, wherein % O2 is the percentage of oxygen in the cone:

[(% O2)×(Volume of Headspace in mL)×(1.429 mg O2/mL O2)]/[(Volume of wine in L in the BiB)]

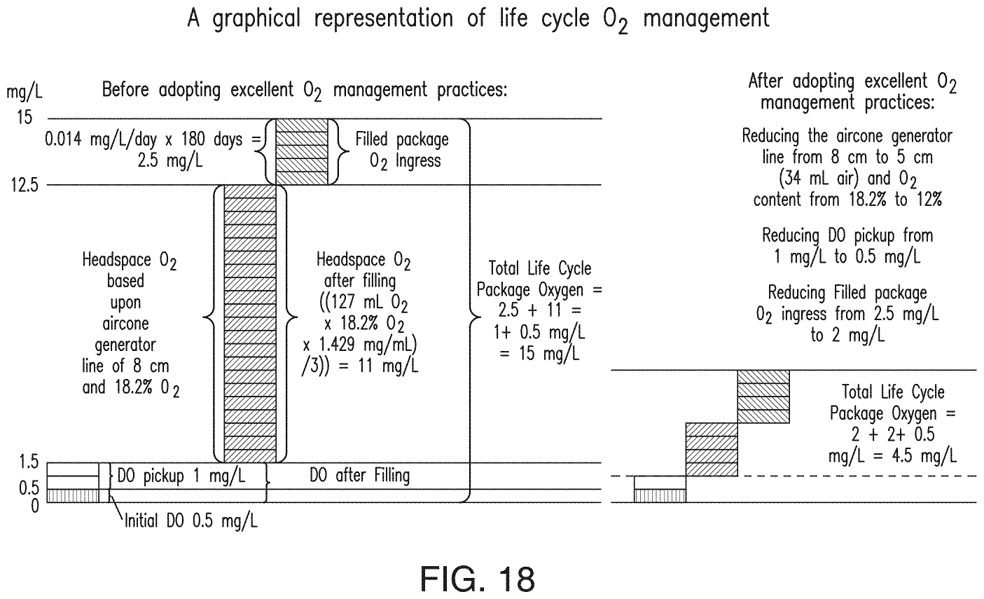

The following Tables depict comparisons of head space within bags between a bag according to the example embodiments in accordance with the disclosure and various commercially available bags. A graphical representation of the life cycle oxygen management can be found, for example, in FIG. 18 (see, also, Shea, P., Vidal J.-C., and Vialis, S., “The Measurement of Total Oxygen in filled BIB wine” B-I-B.com, 29 Nov. 2010).

TABLE 3
Bag Test 1-Control Sample

| Oxygen Source | Oxygen Content | |
|---|---|---|
| Initial Oxygen Before Filling | 0.5 | mg/L |
| Oxygen Pick-up During Filling of Wine | 1 | mg/L |
| Oxygen Transport Through Packaging in | 2.5 | mg/L |
| 180 Days | | |
| Oxygen In Headspace | 3 | mg/L |
| Total Lifecycle Oxygen | 7 | mg/L |

Bag Test 1 was conducted on a first commercially available bag sample in which nitrogen flushing was not performed.

TABLE 4
Bag Test 2-Experimental Sample

| Oxygen Source | Oxygen Content | |
|---|---|---|
| Initial Oxygen Before Filling | 0.5 | mg/L |
| Oxygen Pick-up During Filling of Wine | 1 | mg/L |
| Oxygen Transport Through Packaging in | 2.5 | mg/L |
| 180 Days | | |
| Oxygen In Headspace | 0.04 | mg/L |
| Total Lifecycle Oxygen | 4.04 | mg/L |

Bag Test 2 was conducted on an example embodiment bag sample of the disclosure in which nitrogen flushing was performed with adoption of excellent oxygen management techniques.

TABLE 5
Bag Test 3-Control Sample

| Oxygen Source | Oxygen Content | |
|---|---|---|
| Initial Oxygen Before Filling | 0.5 | mg/L |
| Oxygen Pick-up During Filling of Wine | 1 | mg/L |
| Oxygen Transport Through Packaging in | 2.5 | mg/L |
| 180 Days | | |
| Oxygen In Headspace | 11 | mg/L |
| Total Lifecycle Oxygen | 15 | mg/L |

Bag Test 3 was conducted on a second commercially available bag sample in which nitrogen flushing was not performed, wherein the bag was made using a typical bag manufacturing process.

TABLE 6
Bag Test 4-Control Sample

| Oxygen Source | Oxygen Content | |
|---|---|---|
| Initial Oxygen Before Filling | 0.5 | mg/L |
| Oxygen Pick-up During Filling of Wine | 1 | mg/L |
| Oxygen Transport Through Packaging in | 2.5 | mg/L |
| 180 Days | | |
| Oxygen In Headspace | 1.94 | mg/L |
| Total Lifecycle Oxygen | 5.94 | mg/L |

Bag Test 4 was conducted on the second commercially available bag sample in which nitrogen flushing was not performed, but where the bag was made using a bag manufacturing process that is characterized as “very good” indicated it is improved relative to the “typical” process used in the manufacture of the bag in Bag Test 3.

TABLE 7
Percent Reducton in Oxygen Content

| | | Comparative % Decrease |
|---|---|---|
| | | in Total Life Cycle |
| | Total Life | O2 for Experimental |
| Bag Id. | Cycle O2 | Sample in Bag 2 |

| | | | |
|---|---|---|---|
| Bag 1-Control 1 | 7 | mg/L | 42% |
| Bag 2-Experimental | 4.04 | mg/L | -NA- |
| Bag 3 Control 2 | 15 | mg/L | 73% |
| Typical Manufacturing | | | |
| Bag 4-Control 2, | 5.94 | mg/L | 32% |
| Good Manufacturing | | | |

The bag produced according to example embodiments of the disclosure demonstrated at least a decrease in oxygen content of 32% when compared to the commercially available bags made even under their improved/best manufacturing techniques. When compared to commercially available bags made by typical processes, the bag produced according to example embodiments of the disclosure showed a 73% reduction in total oxygen content in the bag lifecycle. According to the study conducted by the French National Institute for Agricultural Research in 2004, the Test Bag 2, which incorporates the inert/non-oxidizing atmosphere flushing technology disclosed herein (nitrogen, in the example) would effectively extend the shelf life by 3 months or more.

What is claimed is:

1. A flexible bag for packaging a food product, wherein the flexible bag comprises
at least one polymeric film that forms at least one cavity, wherein the at least one cavity comprises a non-oxidizing, inert, or substantially inert gas comprising less than 10% oxygen; and
at least one fitment in closed position on a side, wherein the at least one fitment provides access to the cavity.

2. The flexible bag of claim 1, wherein the flexible bag comprises four sealed edges.

3. The flexible bag of claim 1, wherein the flexible bag comprises more than one cavity, wherein each cavity is formed by two or four layers of at least one polymeric film.

4. The flexible bag of claim 1, wherein at least 90% of the gas comprises nitrogen, argon, helium, or a combination thereof.

5. The flexible bag of claim 1, wherein at least 90% of the gas comprises nitrogen.

6. The flexible bag of claim 1, wherein at least 99% of the gas comprises nitrogen.

7. The flexible bag of claim 1, wherein the bag comprises three cavities: a first cavity, a second cavity, and a third cavity;
wherein the first cavity is defined by a first polymeric film layer and a second polymeric film layer;
wherein the second cavity is defined by the second polymeric film layer and a third polymeric film layer; and
wherein the third cavity is defined by the third polymeric film layer and a fourth polymeric film layer;
wherein the first, second, third, and fourth polymeric film layers are coplanar, and sealed at the edges;
wherein the second cavity is central to the first cavity and the third cavity;
wherein the second cavity is used for filling the product and is connected to the fitment; and
wherein all three cavities, prior to being filled with the product, comprise the gas.

8. The flexible bag of claim 7, wherein:
at least one of the first polymeric film layer or the fourth polymeric film layer comprise metallized PET, metallized BoPA, or clear BoPA; and
at least one of the second polymeric film layer or the third polymeric film layer comprises EVOH co-ex, BoPA co-ex, or a combination thereof.

9. The flexible bag of claim 1, wherein the flexible bag has one cavity that is defined by a first polymeric film layer and a second polymeric film layer;
wherein the first and second polymeric film layers are coplanar, and sealed at the edges; and
wherein the cavity, prior to being filled with product, comprises the gas.

10. The flexible bag of claim 9, wherein the first polymeric film layer and the second polymeric film layer comprise the following layers:
(A) a sealant layer comprising LLDPE;
(B) an OTR-reducing barrier layer comprising metallized PET, metallized BoPA, or clear BoPA, or a combination thereof;
(C) an FCR-improving layer comprising EVOH coex, BoPA co-ex, or a combination thereof.

11. A process for preparing a flexible bag that extends shelf-life of a food product packaged within the flexible bag, the process comprising:
providing at least one polymeric film;
forming the at least one polymeric film to create at least one cavity;
introducing a portion of a non-oxidizing, inert, or substantially inert material into the at least one cavity from an external source;
replacing residual air in the at least one cavity with the material;
sealing the at least one cavity to trap the material inside; and
repeating the above steps for the next flexible bag in a continuous or a stop start process of flexible bag-making.

12. The process of claim 11, wherein the material comprises a gas introduced from an external gas source and comprises nitrogen, argon, helium, or a combination thereof, and wherein the gas is introduced to the cavity through at least one main tube.

13. The process of claim 12, wherein the gas consists essentially of nitrogen.

14. The process of claim 12, wherein the at least one main tube comprises multiple inlet ports for introducing the gas to replace the residual air in the at least one cavity of the flexible bag.

15. The process of claim 14, wherein the multiple inlet ports are located at the ends of multiple sub-tubes emanating from the at least one main tube, and wherein the multiple sub-tubes are of various lengths.

16. The process of claim 15, wherein the multiple-sub-tubes are organized in a gradually-increasing-in-length or a gradually-decreasing-in-length fashion.

17. The process of claim 12, wherein the gas introduced in the at least one cavity is in a turbulent flow.

18. The process of claim 17, wherein the turbulent flow creates a circular flow of the gas that displaces the residual air in the at least one cavity.

19. The process according to claim 11, further comprising:
providing first, second, third, and fourth polymeric film layers;
forming the first, second, third, and fourth polymeric film layers to create first, second, and third cavities;
introducing, from an external source, an amount of a non-oxidizing, inert, or substantially inert material into the first cavity through a first main-tube connected to the first cavity and external source;
introducing, from an external source, an amount of a non-oxidizing, inert, or substantially inert material into the second cavity through a second main-tube connected to the second cavity and external source;
introducing, from an external source, an amount of a non-oxidizing, inert, or substantially inert material into the third cavity through a third main-tube connected to the third cavity and external gas source;
replacing residual air in the three cavities with the material;
sealing the three cavities to trap the material inside; and
optionally sweeping the residual air out, or burping the cavities to remove gas; and
repeating the above steps for the next flexible bag in a continuous or a stop start process of flexible bag-making.

20. The process of claim 19, wherein the material comprises a gas introduced from an external gas source and comprises nitrogen, argon, helium, or a combination thereof.

21. The process of claim 20, wherein the gas consist essentially of nitrogen.

22. The process of claim 19, wherein at least one of the first, second, or third main-tubes comprises multiple inlet ports for introducing the material to replace the residual air in the three cavities.

23. The process of claim 22, wherein the multiple inlet ports are located at the ends of multiple sub-tubes emanating from the first, second, and third main-tubes, and wherein the multiple sub-tubes of at least one of the first, second, and the third main-tubes are of various lengths.

24. The process of claim 23, wherein the multiple sub-tubes of at least one of the first, second, and the third main-tubes are organized in a gradually-increasing-in-length and/or a gradually-decreasing-in-length fashion.

25. The process of claim 20, wherein the gas introduced in the first, second, and/or third cavity, create turbulent flows.

26. The process of claim 25, wherein the turbulent flows create circular flows of the gas that displace the residual air in the first, second, and/or third cavity.

27. A packaged food product comprising:
a food product; and
a flexible bag comprising
at least one polymeric film and that forms a plurality of cavities, wherein one cavity of the plurality of cavities contains a food product and the remaining cavities of the plurality of cavities comprise a non-oxidizing, inert, or substantially inert gas comprising less than 10% oxygen; and
at least one fitment in closed position on a side, wherein the at least one fitment provides access to the cavity containing the food product.

28. The packaged food product of claim 27, wherein said flexible bag has four sealed edges.

29. The packaged food product of claim 27, wherein the plurality of cavities are formed by two layers of polymeric film.

30. The packaged food product of claim 27, wherein at least 90% of the gas comprises nitrogen, argon, helium, and a combination thereof.

31. The packaged food product of claim 27, wherein at least 90% of the gas is nitrogen.

32. The packaged food product of claim 27, wherein at least 99% of the gas is nitrogen.

33. The packaged food product of claim 27, wherein the bag comprises three cavities: a first cavity, a second cavity, and a third cavity;
wherein the first cavity is defined by a first polymeric film layer and a second polymeric film layer;
wherein the second cavity is defined by the second polymeric film layer and a third polymeric film layer;
wherein the third cavity is defined by the third polymeric film layer and a fourth polymeric film layer;
wherein the first, second, third, and fourth polymeric film layers are coplanar, and sealed at the edges;
wherein the second cavity is central to the first cavity and the third cavity;
wherein the second cavity contains the food product and is connected to the fitment; and
wherein said first and third cavities comprise the gas.

34. The packaged food product of claim 33, wherein at least one of the first polymeric film layer or the fourth polymeric film layer comprise metallized PET, metallized BoPA, or BoPA co-ex, or combination thereof; and at least one of the second polymeric film layer or the third polymeric film layer comprises EVOH co-ex, BoPA co-ex, or combination thereof.

35. The packaged food product of claim 27, wherein the food product is selected from: (A) wine, (B) beer, (C) water, (D) milk, (E) a non-alcoholic beverage, (F) an alcoholic beverage not including wine or beer, (G) aerated water, (H) an energy drink, (I) fruit juice, (J) vegetable juice, (K) chemical, and (L) detergent.

36. A packaged food product comprising:
a food product; and
a flexible bag comprising first and second polymeric films that are coplanar and sealed at the edges to form one cavity, wherein the cavity contains the food product; and
at least one fitment in closed position on a side, wherein the at least one fitment provides access to the cavity containing the food product;
wherein the cavity, prior to and after being filled with the food product, comprises a non-oxidizing, inert, or substantially inert gas comprising less than 10% oxygen.

37. The packaged food product of claim 36, wherein the first polymeric film and the second polymeric film each comprise the following layers:
(A) a sealant layer comprising LLDPE;
(B) an OTR-reducing barrier layer; and
(C) an FCR-improving layer comprising EVOH coex.

38. The packaged food product of claim 37, wherein the OTR-reducing barrier layer comprises metallized PET, metallized BoPA, or BoPA co-ex, or a combination thereof.

39. The packaged food product of claim 36, wherein the food product is selected from: (A) wine, (B) beer, (C) water, (D) milk, (E) a non-alcoholic beverage, (F) an alcoholic beverage not including wine or beer, (G) aerated water, (H) an energy drink, (I) fruit juice, (J) vegetable juice, (K) chemical, and (L) detergent.
